(19) United States
(12) Patent Application Publication
(10) Pub. No.: US 2002/0120533 A1
(43) Pub. Date: Aug. 29, 2002

(54) Method and system for management of ordering, production, and delivery of made-to-specification goods

(76) Inventor: Hubert Wiesenmaier, Pelham, NY (US)

Correspondence Address: KILPATRICK STOCKTON LLP, 607 14TH STREET, N.W., SUITE 900, WASHINGTON, DC, 20005, US

(21) Appl. No.: 10/080,517

(22) Filed: Feb. 25, 2002

Related U.S. Application Data
(60) Provisional application No. 60/270,639, filed on Feb. 23, 2001.

(51) Int. Cl. G06F 17/60

(52) U.S. Cl. 705/27

(57) ABSTRACT

A system for managing the ordering, production, and delivery of made-to-specification goods. The system includes a computer program product configured as a network application service provider. The computer program product includes a purchase order module operative to create purchase order data sets in cooperation with a buyer user, and notify a vendor user of the creation of each purchase order data set. The program includes a production schedule module operative to indicate acceptance status of each purchase order data set in cooperation with a vendor user and notify the creator of each purchase order of the acceptance status of that PO. In addition, the production schedule module will, for each accepted PO, create a production schedule data set in cooperation with the accepting vendor user, and notify a forwarder/consolidator user and the creator of the purchase order data set corresponding to the production schedule data set of the creation of each production schedule data set. Also, preferred embodiments of the invention include a shipping information module operative to create a shipping information data set in cooperation with a forwarder/consolidator user for each production schedule data set, and notify a customs broker user, each creator of the corresponding purchase order data set and the production schedule data set of the creation of the shipping information data set. Preferred embodiments include a viewing module operative to allow each notified user to view and print each date set for which that user has been notified.

### CROSS-REFERNCE TO RELATED APPLICATIONS

This application claims priority to co-pending U.S. Provisional Patent Application 60/270639 entitled Method and System for Management of Ordering, Production, and Delivery of Made-To-Specification Goods, filed Feb. 23, 2001.

### BACKGROUND

1. Field of the Invention

The present invention pertains to systems and methods for management of information regarding ordering, production, and delivery of made-to-specification goods.

2. Description of Related Art

For illustrative purposes, the description of related art provided herein focuses on apparel manufactured abroad for import by wholesalers.

Apparel importers or wholesalers (hereinafter generally referred to as “importers” and “buyers”) typically do not order from manufacturer's stock. Rather, importers typically will specify style, size, material, and other attributes of the apparel; evaluate the availability of materials and applicable quotas; negotiate price and schedule; and contract apparel manufacturing with independent manufacturers abroad. To ensure timely delivery to retailers, importers are generally desirous of tracking the progress of apparel ordered and manufactured in this fashion.

Current approaches do not offer an integrated approach to tracking such progress. General cargo tracking capabilities are offered by many freight carriers and forwarder/consolidators, but such capabilities track apparel as freight—typically providing information only at the container level, with sparse detail as to individual contents, and does not track the ordering and production processing regarding the apparel before it its picked up by the forwarder/consolidator. Inventory control software applications developed for the manufacturer/vendors typically lose track of the apparel when shipped.

Neither of these types of solutions typically accommodates input by the full spectrum of parties involved in such transactions. The external interfaces provided by such solutions typically are accessible from a single computer or a few computers on a local area network (LAN). As a result, apparel wholesalers expend substantial resources gathering and correlating a wide variety of information from a disparate array of sources. The integrity (completeness, currency, accuracy) of such information is often below the standard desired by importers. In addition, existing approaches are typically not proactive in automatically alerting participants of deviations, either actualized or impending, in the planned ordering and production of goods.

### SUMMARY OF THE INVENTION

Embodiments of the invention provide data set collection, management, and reporting for apparel importers seeking to maintain control and expedite production, shipment, and delivery of merchandise. In one embodiment, the invention is an application-service provider (ASP), harnessing the power of database applications with the ubiquity of the World Wide Web. In that embodiment, and in others similar to it, the invention provides service to customers on a co-branded, OEM basis (e.g., www.<importername>.<ASP name>.com) allowing each customer to maintain a distinct identity for their respective databases, facilitating security of data, and allowing the ASP to provide customized data reporting and entry where needed.

To apparel importers and their vendors, embodiments of the invention maintain and provide useful information for Pre-production Planning and Material Sourcing, Purchase Order (PO) Management, Logistics Management, and Customs Clearance, for each order, production run, shipment and delivery of apparel products. A system of the present invention allows for inclusion of Quota and Landed-Cost Evaluation data management. These data sets are enhanced through advanced reporting and functionality to allow for online, near-real-time assessment and reports on the status of each order, manufacturing process, shipment and delivery at any point along the supply chain.

Preferred embodiments are designed as an online database management application for importers and their vendors providing importers with online visibility over a substantial portion of the supply chain process. These embodiments allow for the input of data from various points along the supply chain and allow for access and reporting of relevant data in multiple forms by importers, vendors, and their service providers (e.g., buying agents, forwarder/consolidators, customs brokers, etc) on a routine, on-demand, and near-real-time basis.

Supply chain data encompass typical elements of the transaction, including

Pre-Production & Sourcing Planning data typically includes these data elements:

style, quota category, Harmonized Tariff Schedule (HTS) number

possible vendors, vendor ID codes, vendor's country of origin and selling terms.

fabric, trim and yam details (color, construction, weight), suppliers, country of origin

fit and Assortment Details (fabric/cutting/trim) assortment Samples (sample exchanges until final counter sample is agreed upon)

time and Action Plan for fabric and trim supply due dates, cutting/sewing/finishing, quota reservations/commitments, regular and quick response production schedules, regular and quick response FOB prices, transportation modes, transit and delivery schedules.

PO Management:

approval of samples by buyer;

production planning and PO fulfillment, work-in-progress reports, and projected/revised/actual, order finishing schedules;

work-in-progress tracking;

online Packing Lists and Invoices;

generating Bar-code labels and price tickets (store pre-ticketing);

quota verification;

factory compliance certification;

inspection; and

delivery of POs to forwarders/carriers/consolidator;

Logistics Management:

forwarder's/consolidator's “received for shipment” reports;

ship/hold/distribution instructions to forwarders or consolidators;

visa and import documentation verification;

pre-shipment advice;

shipping confirmation;

cargo in-transit tracking; and

import document distribution confirmation.

Customs Clearance:

availability of clearance documents/exception reports/request for documents;

projected/actual cargo availability at pier;

Customs clearance status;

instructions/confirmation for delivery of a PO to the destination

Management Reports:

exception reports in regards to projected/revised/actual manufacturing, delivery, and shipping schedules, as well as quotas, visas, and import clearance documentation;

reliability/efficiency reports: vendors, consolidators, ocean and air carriers, Customs Brokers, inland carriers.

Quota and Landed-Cost Evaluation:

availability of quotas;

landed duty, freight and miscellaneous cost calculations

In a preferred embodiment, the invention includes a system for managing the ordering, production, and delivery of made-to-specification goods. The system includes a computer program product configured as a network application service provider. The computer program product includes a purchase order module operative to create purchase order data sets in cooperation with a buyer user, and notify a vendor user of the creation of each purchase order data set. The program includes a production schedule module operative to indicate acceptance status of each purchase order data set in cooperation with a vendor user and notify the creator of each purchase order of the acceptance status of that PO. In addition, the production schedule module will, for each accepted PO, create a production schedule data set in cooperation with the accepting vendor user, and notify a forwarder/consolidator user and the creator of the purchase order data set corresponding to the production schedule data set of the creation of each production schedule data set. Also, preferred embodiments of the invention include a shipping information module operative to create a shipping information data set in cooperation with a forwarder/consolidator user for each production schedule data set, and notify a customs broker user, each creator of the corresponding purchase order data set and the production schedule data set of the creation of the shipping information data set. Preferred embodiments include a viewing module operative to allow each notified user to view and print each date set for which that user has been notified.

### DESCRIPTION OF THE SEVERAL VIEWS OF THE DRAWINGS

FIG. 1 illustrates an example login page of a preferred embodiment of the present invention.

FIG. 2 illustrates an example importer welcome page of a preferred embodiment of the present invention.

FIG. 3 illustrates an example purchase order creation window of a preferred embodiment of the present invention.

FIG. 4 illustrates an example purchase order line item creation window of a preferred embodiment of the present invention.

FIG. 5 illustrates an example updated purchase order line item window of a preferred embodiment of the present invention.

FIG. 6 illustrates an example new purchase orders window of a preferred embodiment of the present invention.

FIG. 7 illustrates an example vendor user welcome window of a preferred embodiment of the present invention.

FIG. 8 illustrates an example of a preferred embodiment of the present invention.

FIG. 9 illustrates an example message window of a preferred embodiment of the present invention.

FIG. 10 illustrates an example new purchase orders window of a preferred embodiment of the present invention.

FIG. 11 illustrates an example importer user's message window of a preferred embodiment of the present invention.

FIG. 12 illustrates an example importer's view purchase orders in pre-production window of a preferred embodiment of the present invention.

FIG. 13 illustrates an example vendor user's view pre-production window of a preferred embodiment of the present invention.

FIG. 14 illustrates an example vendor user's schedule creation window of a preferred embodiment of the present invention.

FIG. 15 illustrates an example vendor user's schedule creation window with two entered tasks of a preferred embodiment of the present invention.

FIG. 16 illustrates an example of a message window for an importer user showing, inter alia, several alert messages of a preferred embodiment of the present invention.

FIG. 17 illustrates an example importer user's List All Pre-Production Purchase Orders window of a preferred embodiment of the present invention.

FIG. 18 illustrates an example production schedule viewing window of a preferred embodiment of the present invention.

FIG. 19 illustrates an example exception report window of a preferred embodiment of the present invention.

FIG. 20 illustrates an example vendor user's List all Pre-Production POs window of a preferred embodiment of the present invention.

FIG. 21 illustrates an example vendor user's production schedule update window of a preferred embodiment of the present invention.

FIG. 22 illustrates an example List all POs in Shipping window of a preferred embodiment of the present invention.

FIG. 23 illustrates an example packing list (first part) of a preferred embodiment of the present invention.

FIG. 24 illustrates an example packing list (second part) of a preferred embodiment of the present invention.

FIG. 25 illustrates an example packing list window of a preferred embodiment of the present invention.

FIG. 26 illustrates an example set of bar code labels printable from a preferred embodiment of the present invention.

FIG. 27 illustrates an example forwarder/consolidator welcome window of a preferred embodiment of the present invention.

FIG. 28 illustrates an example of a preferred embodiment of the present invention.

FIG. 29 illustrates an example forwarder/consolidator message window of a preferred embodiment of the present invention.

FIG. 30 illustrates an example Shipping Information window of a preferred embodiment of the present invention.

FIG. 31 illustrates an example Packing List creation window of a preferred embodiment of the present invention.

FIG. 32 illustrates an example customs broker welcome window of a preferred embodiment of the present invention.

FIG. 33 illustrates an example customs broker user's message window of a preferred embodiment of the present invention.

FIG. 34 illustrates an example List all POs In Shipping window of a preferred embodiment of the present invention.

FIG. 35 illustrates an example shipping information window of a preferred embodiment of the present invention.

FIG. 36 illustrates an example notifications/alert/message window of a preferred embodiment of the present invention.

FIG. 37 illustrates an example List all Finished Purchase Orders window of a preferred embodiment of the present invention.

FIG. 38 illustrates an example exception report of a preferred embodiment of the present invention.

FIG. 39 illustrates an example hypertext link to an exception report of a preferred embodiment of the present invention.

FIG. 40 illustrates an example purchase order management window 4000 for an importer user of a preferred embodiment of the present invention.

FIG. 41 illustrates an example change history for a purchase order window of a preferred embodiment of the present invention.

FIG. 42 illustrates an example window for modifying viewing permissions of users of a preferred embodiment of the present invention.

FIG. 43 illustrates an example window for controlling access by company type, by company and by individual users within a company of a preferred embodiment of the present invention.

FIG. 44 illustrates an example color code management window of a preferred embodiment of the present invention.

### DETAILED DESCRIPTION OF THE INVENTION

By positioning preferred embodiments of the invention to be a service delivered on an ASP basis, these embodiments harness ubiquity of the World Wide Web to interface with participants, e.g., vendors and importers, for both reporting and data entry functions.

Each authorized participant/user is enabled to enter and view data, generate appropriate documents and add appropriate data to the system by accessing the importer's web site at the ASP. The system is accessed and used effectively through simple hardware and software infrastructure for these participants and users. No more complicated access tools than a Pentium class personal computer (PC) with a display resolution of at least 800×600 pixels, a suitable web browser (Microsoft Explorer Web Browser version 4 or higher or the comparable Netscape browser), and a communications modem (at least 56 k) or a faster broadband connection are required. Users will be requested to also have an inkjet or laser printer for printing packing lists, invoices, bar-code labels, and reports.

Each importer web site at the ASP will be secured through a password system. The system includes functionality to allow the ASP provider to develop a system of User IDs and Passwords, which will be assigned to each importer. Each importer in turn and in coordination with the ASP provider is responsible for assigning User IDs and Passwords to the importer's individual personnel and vendors, buying agents, forwarder/consolidators, customs brokers, and others who will be authorized participants and users of that importer's web site at the ASP. A system of the present invention allows individual importers to tailor their own standards for access to information and reports for each of the various participants in their individual supply chain.

For instance, the importer may determine that complete PO management information can be entered, and will be available for viewing, only by the importer, the vendor, and the importer's buying agent. The ability to generate the pre-shipment exception reports will typically be available to the importer's forwarder or cargo consolidator only, while data and reports about customs clearance and on-forwarding will be entered by the importer's customs broker only.

In an illustrative embodiment, to gain access to the importer's web site at the ASP, the participant directs their browser to the importer's web site URL at the ASP. The general format is as follows:

### http://www.<importer name>.<ASP name>.com

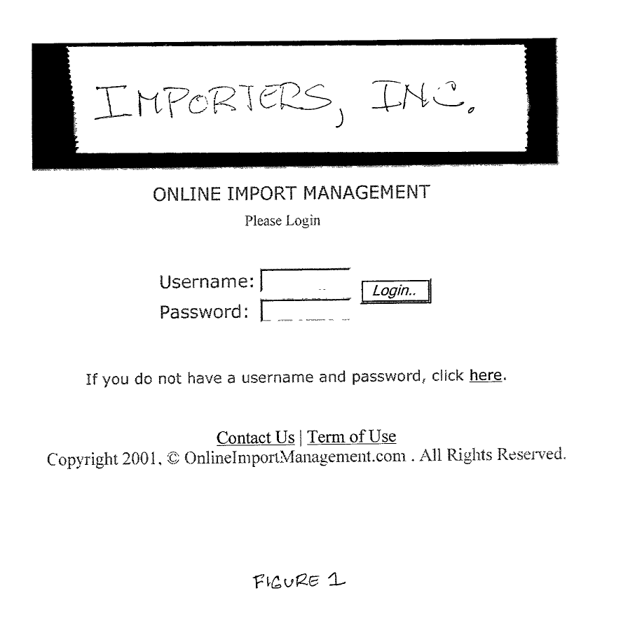

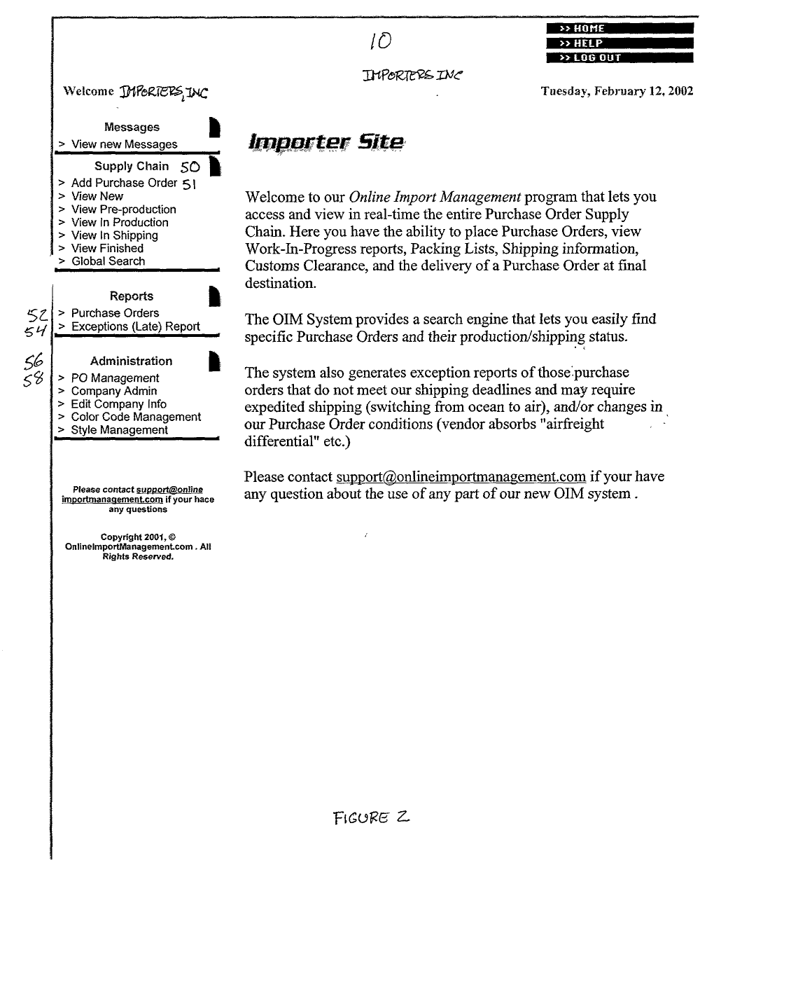

See FIG. 1 for an example login page for each user and FIG. 2 for sample content of an importer's welcome page.

In preferred embodiments, data to be entered and viewed online is grouped into information-clusters focusing on:

a) Pre-production and Source Planning

b) Production management including generating Online Packing Lists, Invoices, and Bar-code labels;

c) Logistics Management;

d) Customs Clearance,

e) Exceptions and other management benchmarking reports.

As indicated, the system preferably includes Quota and Landed Cost Evaluation databases and tools. In a preferred embodiment of the invention, selected functionality is presented to users based on user type, e.g., importer/importer employee, buying agent, vendor, and logistics service provider.

An embodiment of the invention provides one or more templates to guide the user in the entry of data for each of these information clusters. Once information is entered into the database through one template, the system preferably recalls and reports the same data in any other entry template for the same transaction when an authorized participant at a different point on the supply chain accesses the related templates for data entry with a valid PO (PO) number, i.e., one that was assigned to the vendor accessing the system—or a PO number that a service provider or buying agent was authorized to access.

Information that ties these templates together includes the transaction PO number. Thus various search tools, which participants will use to establish access to relevant transaction data at any point along the supply chain, will be focused on PO numbers. In turn, select PO details flow into all ASP templates and reports. This data will typically be input by the importer of the merchandise. As other participants along the supply chain access the ASP system to enter their relevant information to the database, entry of the PO number will cause the basic PO data to flow to the data entry template appropriate for the supply chain participant.

Data entered into the OIM system through the PO Management and Production Management templates is available for reporting in various formats. Preferred embodiments provide confirmative screens for certification of vendor, forwarder/consolidator, buying agent, and customs broker compliance with applicable laws, regulations, and conventions.

Preferred embodiments provide multiple Packing List reports that vendors can access, and use to generate packing lists for each transaction. This system allows the vendor to integrate PO management and Production Management data in a standard packing list report to confirm that the production run conforms to the PO specifications. Thus, when entering a PO number the appropriate template (customized for dimensions/sizes etc) will pop up for generating a packing list. It will show the name and address of the vendor as shown on the PO template as the “header” of the Packing List—as well as the basic PO information. The color tablet information (colors, sizes, descriptions, units, etc) will also be retrieved from PO data and shown in the appropriate Packing List information fields. The vendor can generate this report, crosscheck conformity with the Production Management data, and thus confirm production against PO

Preferred embodiments of the invention generate exception reports when e.g., a data field is not completed by the appropriate supply chain participant, or where an authorized participant makes a change to the established data in a particular field, or when last dates for delivery are compromised by production or shipping delays beyond specified parameters. The Exception Report generates an email notice to the importer and the relevant supply chain participant informing the participant of the exception found by the ASP and allowing the parties to coordinate remedying the situation.

As indicated earlier in this disclosure, for illustrative purposes, the description of related art provided herein focuses on apparel manufactured abroad for import by wholesalers. For other made-to-specification items of manufacture, specific parameters used in each screen may differ, but as in the enabling embodiment of this disclosure, those parameters include a range sufficient to specify the items.

As an example, consider the following preferred embodiment of the present invention.

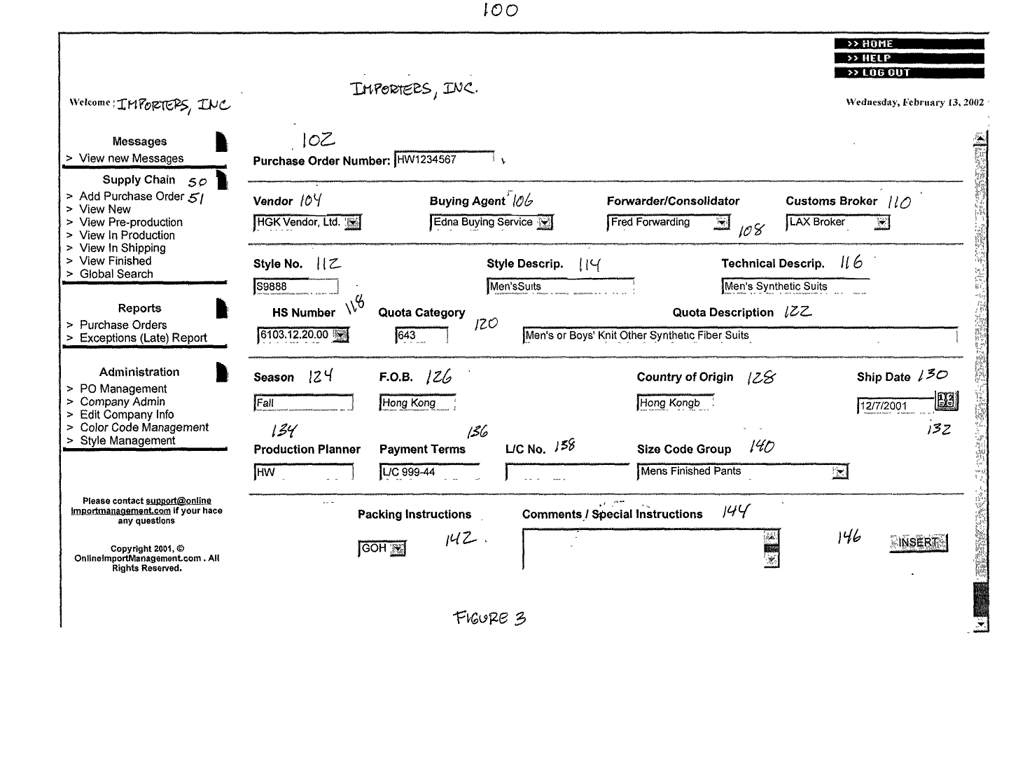

FIG. 3 illustrates a PO creation window 100 available to a user identified as an importer. This window 100 is chosen from the main Importer Site window 10 (illustrated in FIG. 2) by selecting Add PO hypertext 51 from the Supply Chain menu 50. Through this window, an importer user may create a PO by the following steps. The importer user provides a PO Number 102. The importer user selects a vendor 104, buying agent 106 forwarder/consolidator 108, and customs broker 110. The importer user assigns a Style Number 112 along with a corresponding Style Description 114 and Technical Description 116 . Through use of a pull down menu, the importer user selects a Harmonized Tariff Schedule (HS) Number 118. Selection of the HS Number 118 determines the Quota Category 120 and corresponding Quota Description 122. In a similar fashion, the importer user indicates Season 124, F.O.B. location 126 (typically a city or port), and Country of Origin 128. Ship Date 130 is indicated in the format mm/dd/yyyy by direct entry or by choosing a date from the calendar button 132 adjacent to the data entry pane 130. The window 100 allows an importer user to identify a Production Planner 134, indicate Payment Terms 136, and indicate Letter of Credit (L/C) Number 138. Size Code Group 140 is chosen from a pull down menu; the choice determines the specific format of the PO. The importer user may indicate Packing Instructions 142 by selecting a type from the pull-down menu connected to the Packing Instructions data pane 142. A pane is provided for free-text Comments/Special Instructions 144. A new PO can be saved using the Insert button 146. At this point, the header data for the PO has been collected.

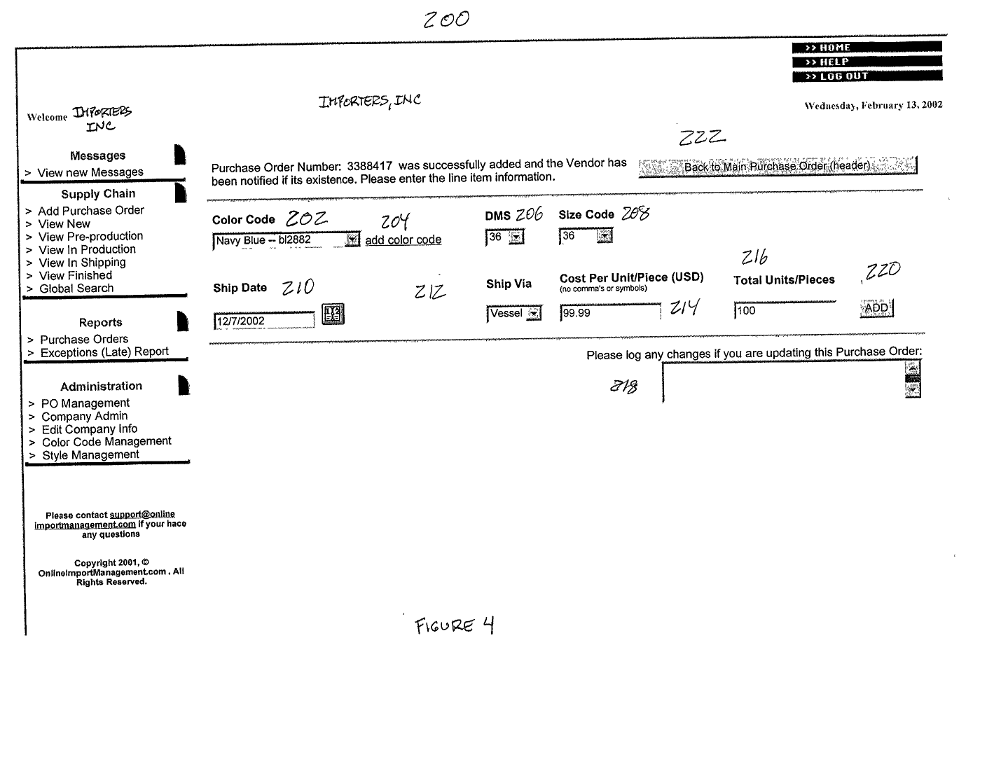

Next the importer user enters line items for the new PO. FIG. 4 illustrates a window 200 of the present invention for providing information for one line item at a time. The importer user chooses a color code from the pull down menu 202 or chooses to add a color code 204 via another window described below. In a similar fashion, the importer user chooses DMS Code 206 and Size Code 208, each from a pull down menu. Options in the DMS Code 206 and Size Code 208 menus are determined by the Size Code Group 140 chosen in the PO main menu 100. The Ship Date 210 is carried over from the PO main menu 100. The importer user selects a Shipping mode 212 from a pull down menu and indicates the Cost Per Unit/Piece 214 and Total Units/Pieces 216 for that PO line item. A change log pane 218 is provided for free text comments regarding the PO. A new line item can be added to the PO using the ADD button 220. At any time, the user may return to the PO main window via the Back to Main PO (header) button 222.

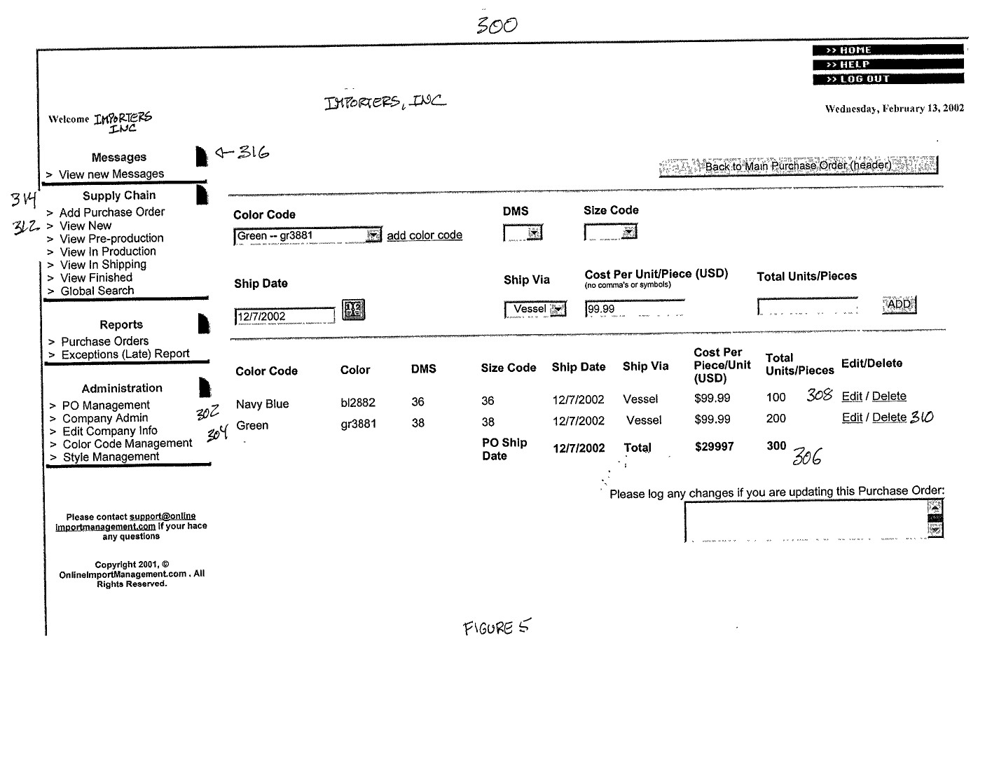

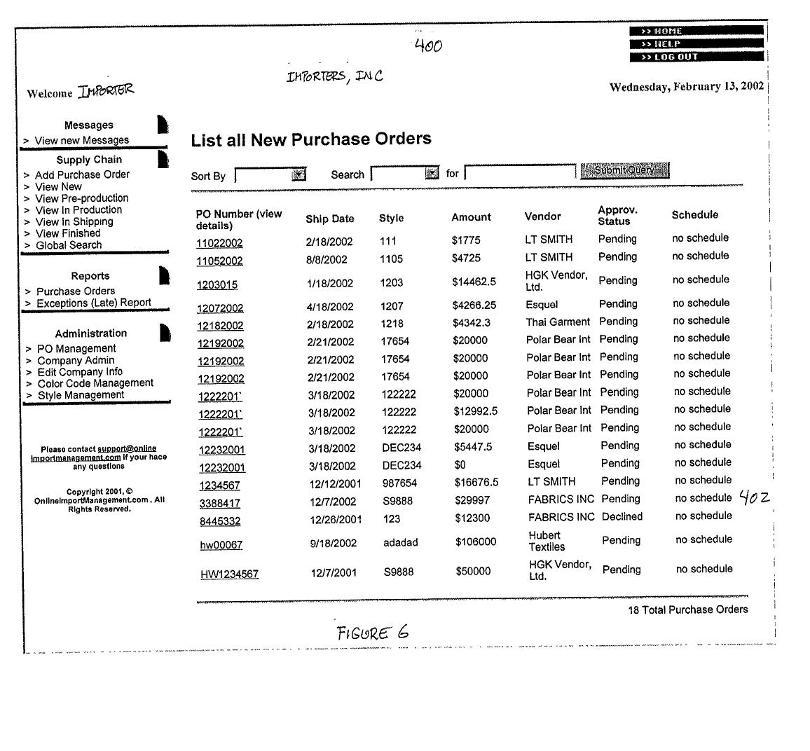

FIG. 5 illustrates an updated line item window 300 with two line items 302, 304 already entered. The window 300 tallies total cost and total pieces 306, provides access to a PO line item Edit window through an Edit button 308, and allows a user to Delete 310 a line item. As indicated in FIG. 6, the entered PO#3388417 402 is now listed among other new POs in a New POs window 400 accessible via the View New hypertext 312 in the Supply Chain portion 314 of the main menu 316. At this point, other than edits or deletions, the importer user has completed data entry regarding the PO.

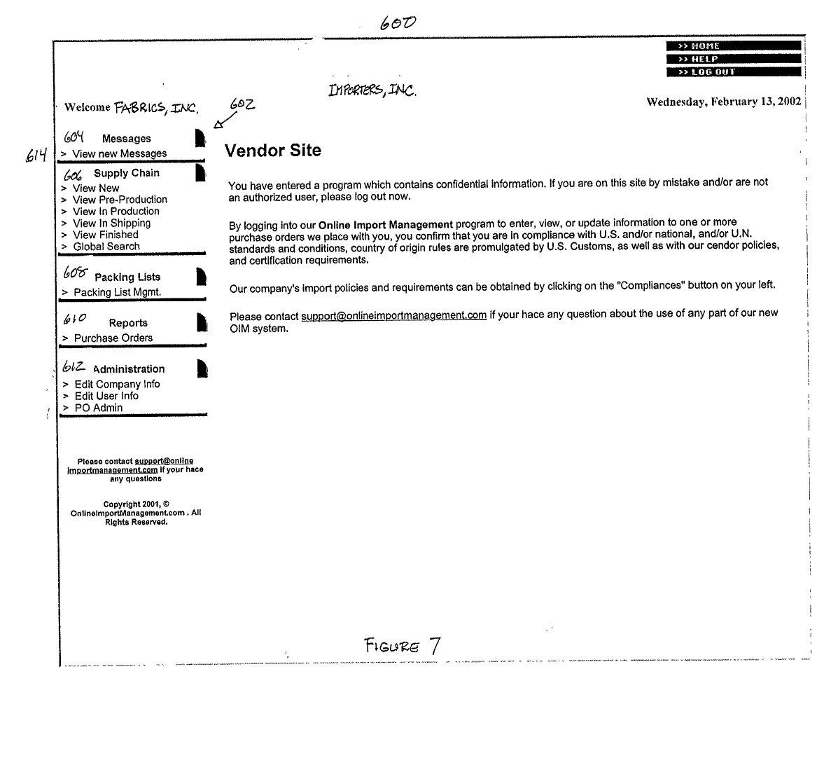

As indicated in FIG. 7, after providing a valid user ID and password, an authorized vendor user is greeted with a window 600 briefly identifying the site as confidential; reminding the user that logging on as a vendor user is an act confirming and representing that the user, as an apparel import vendor, is in compliance with U.S. and/or national, and/or United Nations standards and conditions, country of origin rules promulgated by U.S. Customs, as well as with the vendor user policies, and certification requirements included elsewhere in the site and in agreements with the site Operator and Importer.

A user logged in as a vendor user is offered a main menu 602 of choices more limited than that available to a user logged in as an importer user. Specifically, a vendor user may not create or edit a PO. Vendor users have access to Message functions 604, Supply Chain functions 606, Packing List functions 608, PO Reports 610, and Administration functions 612 depending on the level of access granted to a particular user—discussed elsewhere in this disclosure.

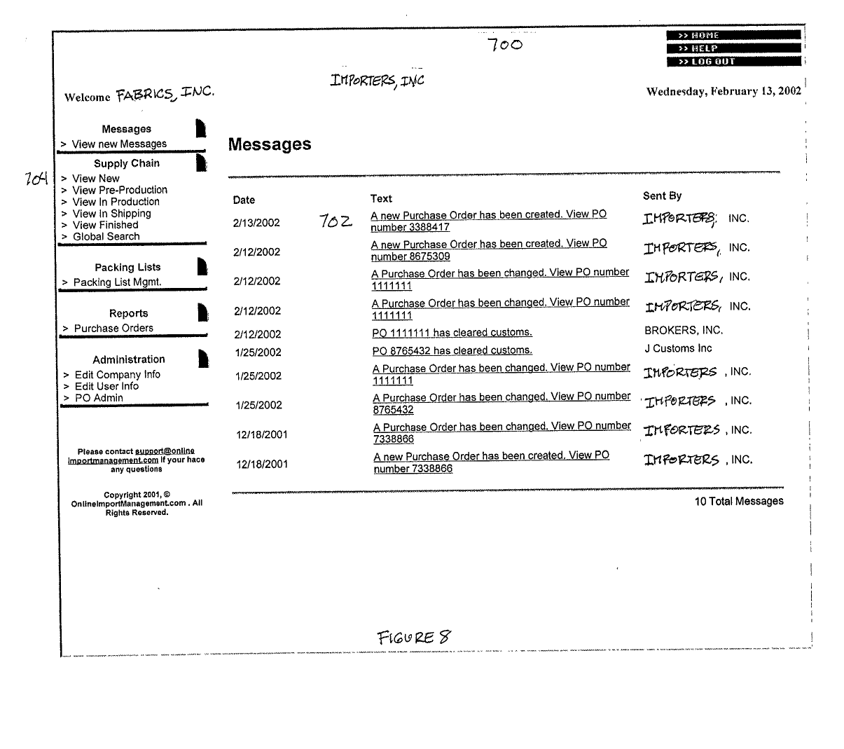

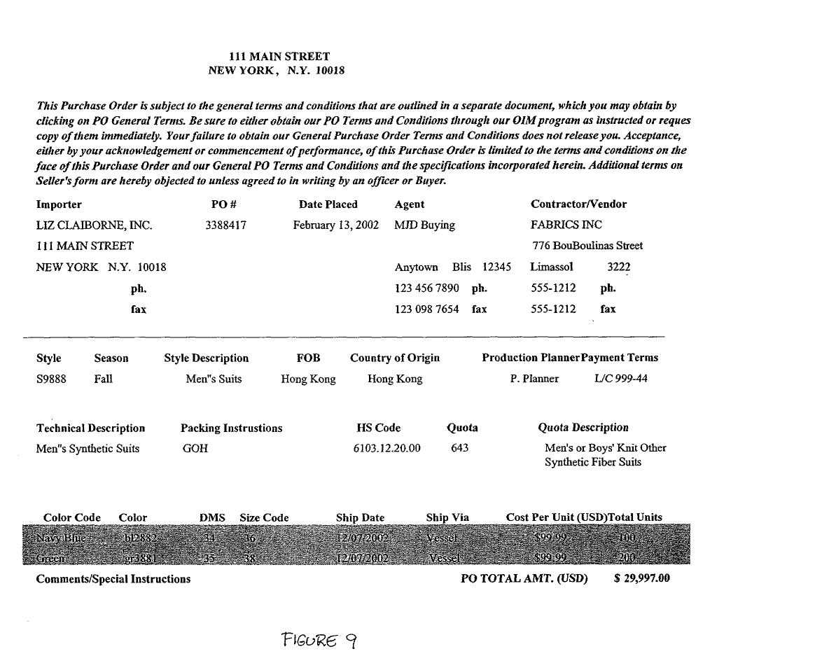

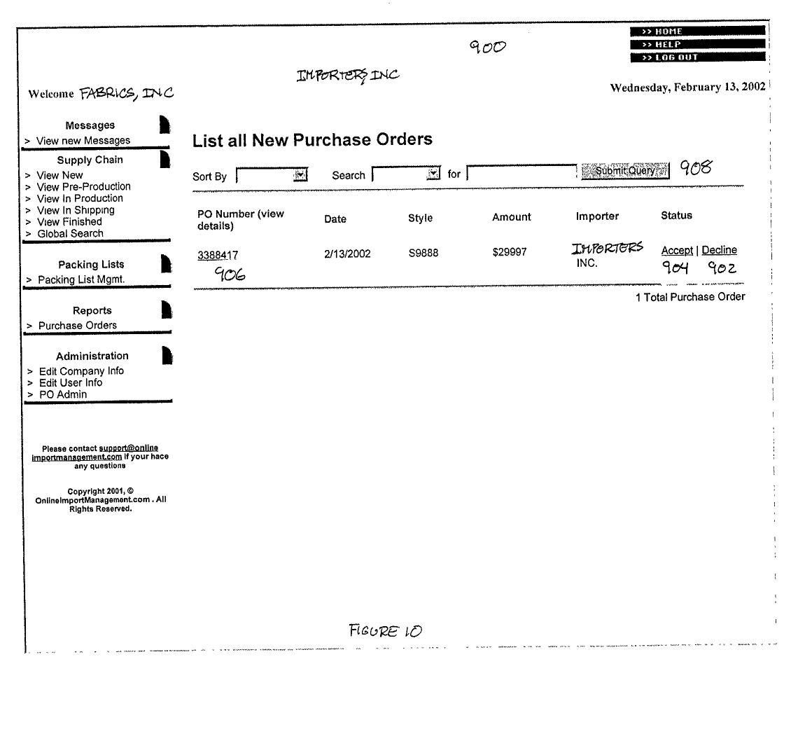

Continuing with the PO created above in the description for importer user functions, by selecting the View new Messages choice 614 from the vendor user site window 600, the user is presented with a Messages window 700 as shown in FIG. 8. As illustrated in FIG. 8, completion of PO#3388417 has triggered a message 702 to the vendor FABRICS, INC from the importer IMPORTERS, INC. This new PO can be viewed by selecting the message hypertext 702. This view of the PO is illustrated in FIG. 9 and is not interactive. An interactive view of the new PO is accessible via the View New menu choice 704 shown in FIG. 8. Selecting this choice present the user with a List of All New POs window 900 illustrated in FIG. 10.

Selection of the Decline 902 choice shown in FIG. 10 will trigger a message to that effect to the importer user that created the PO, allowing the importer user to edit the PO identifying another vendor user who would then be offered the same choice to Decline 902 or Accept 904. The vendor user may choose to view the details of the PO by selecting the PO number 906. This selection offers the vendor user the non-interactive view of the PO illustrated in FIG. 9. While FIG. 10 indicates only one new PO, a plurality of POs may be indicated, each as by the header information in the pattern shown for PO#3388417. Sort and search capability 908 is provided in the List of All New POs window 900 as shown. A vendor user may indicate acceptance of a PO using the Accept choice 904.

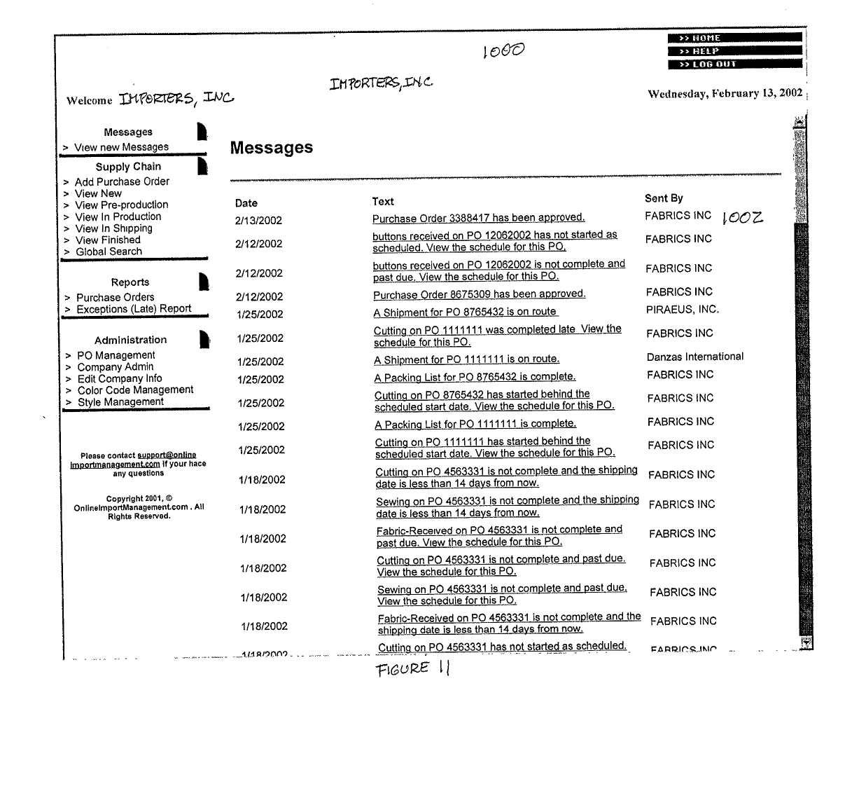

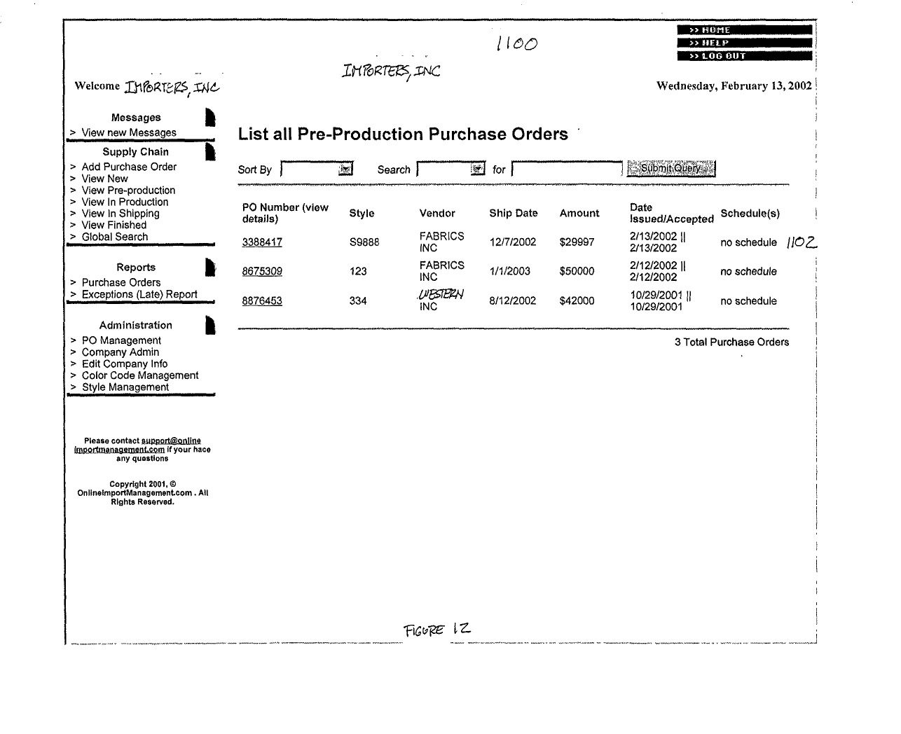

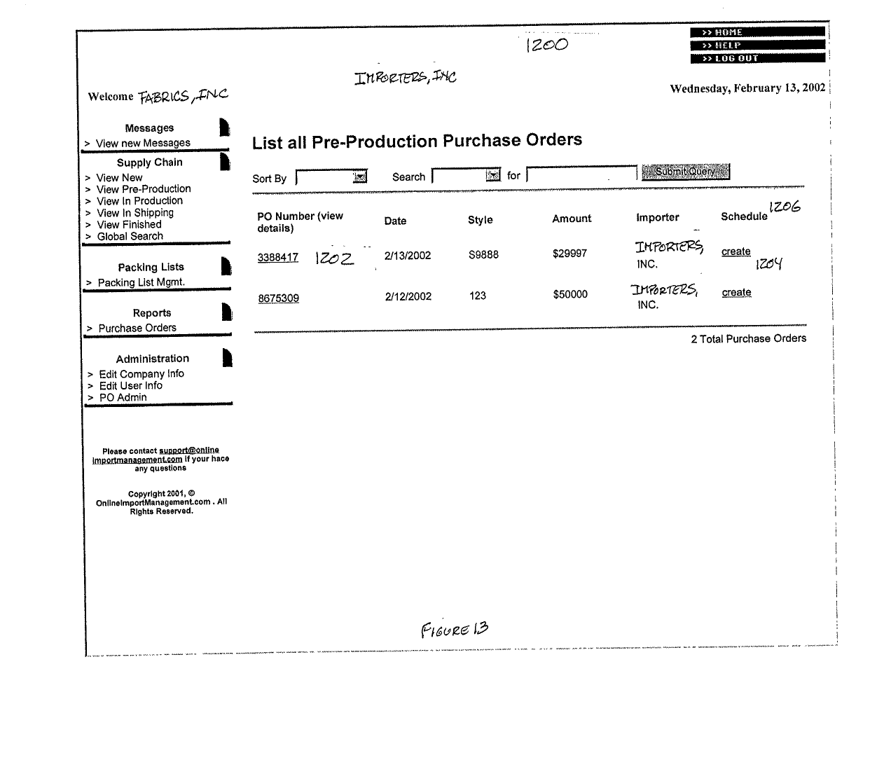

Acceptance of a PO removes the header information for that PO from the List of All New POs window 900, and generates an approval message 1002 as shown in FIG. 11 which illustrates the importer user's Messages window 1000—accessible by the appropriate importer user via the View new Messages hypertext in the importer user's main menu. In addition, acceptance of the PO causes an entry for the PO 1102 to appear in the View Pre-Production window (illustrated in FIG. 12 as an importer user window) 1100 available to both the importer user and the vendor user. FIG. 13 illustrates the View Pre-Production window 1200 for a vendor user, with the entry 1202 for PO#3383417. From this window 1200, a vendor user may elect to create a production schedule by choosing the Create hyper text 1204 in the Schedule column 1206, in the row corresponding to the PO entry (in this case PO#3383417 1202).

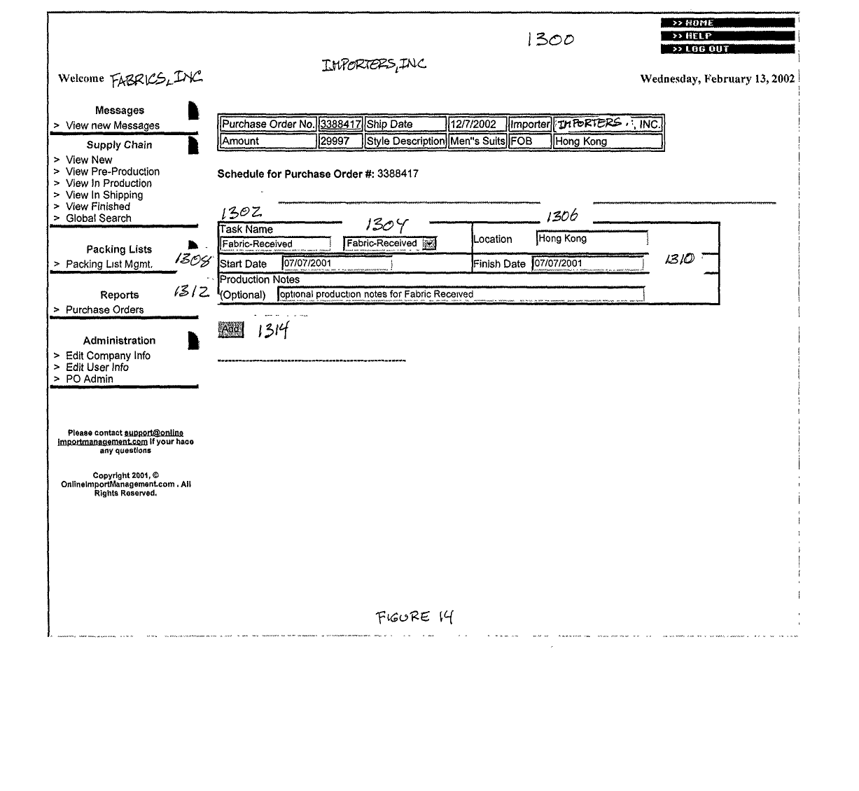

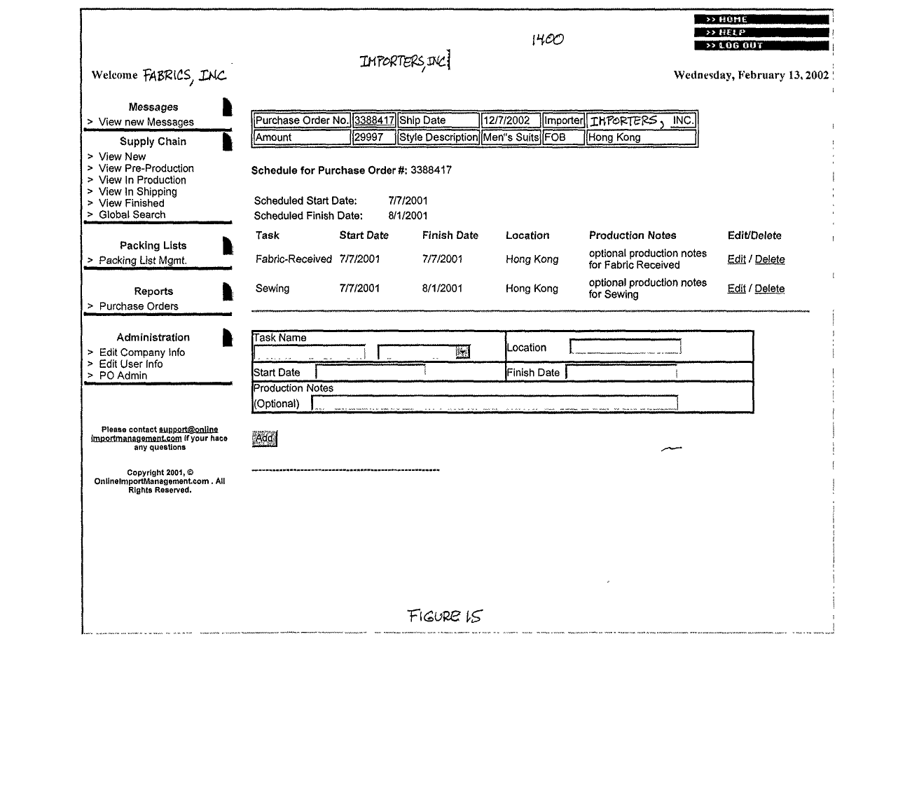

That choice will bring a vendor user to the schedule creation window 1300 illustrated in FIG. 14. As with the PO Line Item window 200, each schedule task is individually entered in the schedule creation window 1300. Schedule tasks are specified by task name, which may be entered into the Task Name pane 1302, or selected from a pull down menu of task names 1304. The location of the task, along with scheduled start and finished dates, are entered in the appropriate panes 1306, 1308, 1310. A free text field for optional Production Notes 1312 related to the particular task is also provided. FIG. 14 contains data for a sample task “Fabric Received.” Selecting the ADD button 1314, enters the task into the schedule for the PO. FIG. 15 illustrates two tasks entered into the schedule for PO#3388417.

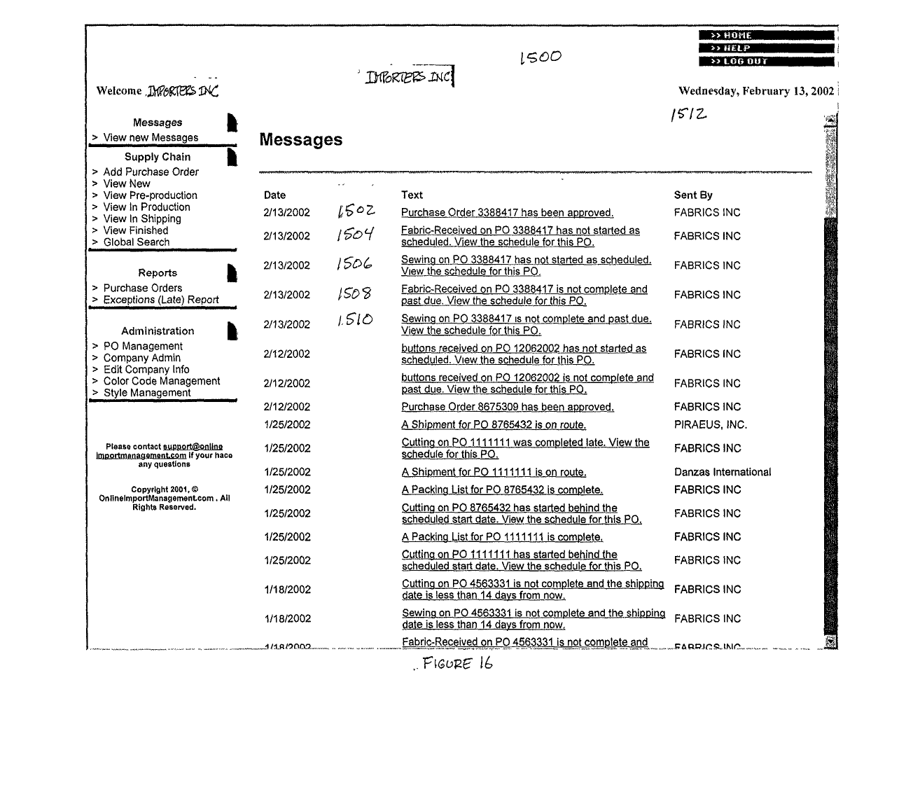

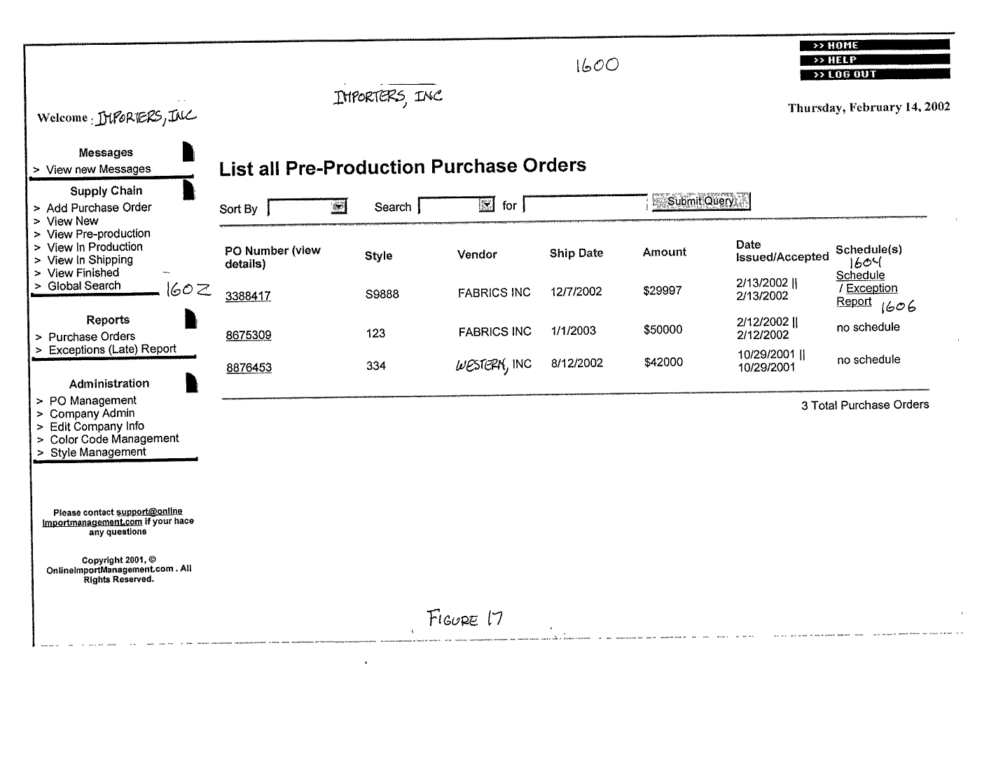

FIG. 16 illustrates the Message window for the importer user. The first five (5) messages 1502, 1504, 1506, 1508, 1510 relate to PO#3388417. The first message 1502 indicates that PO#3388417 has been accepted by the assigned vendor. The next four (4) messages 1504, 1506, 1508, and 1510 result from schedule end dates being entered for a task and the task not being indicated as completed by the current date 1512. Selecting the hypertext for the first message 1502 takes the user to the importer user's List All Pre-Production POs window 1600 as shown in FIG. 17.

Regarding FIG. 17, the entry for PO#3383417 1602 is indicted as having a schedule and exception reports. Since actual start or finish dates have yet to be entered for any of the tasks under this PO, the PO is still indicated as being “pre-production.”

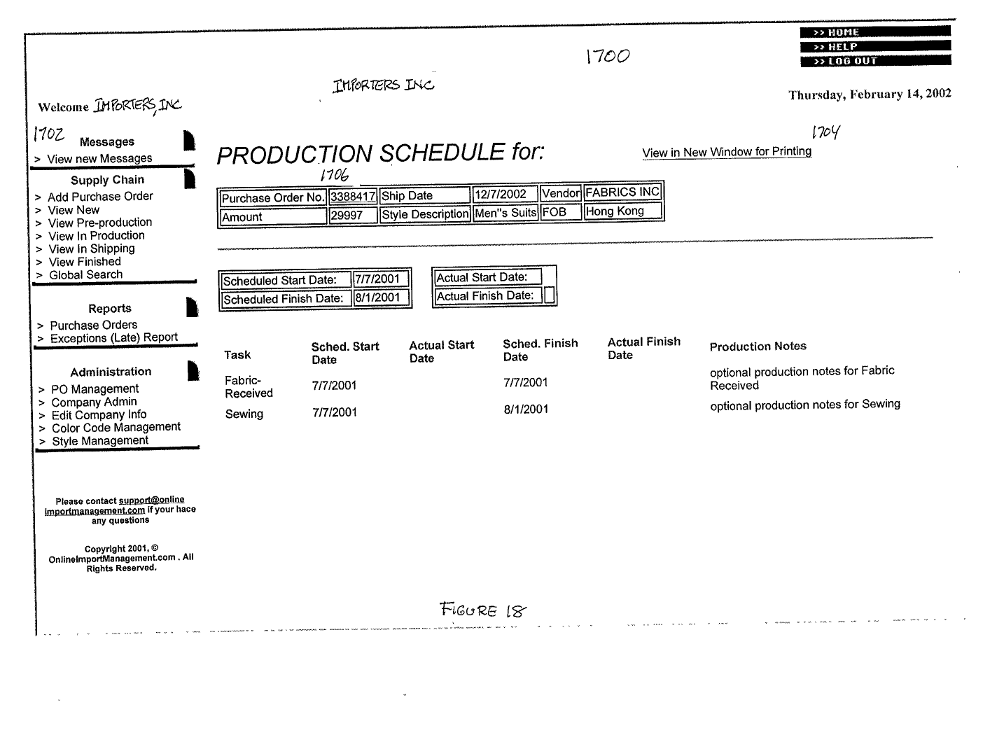

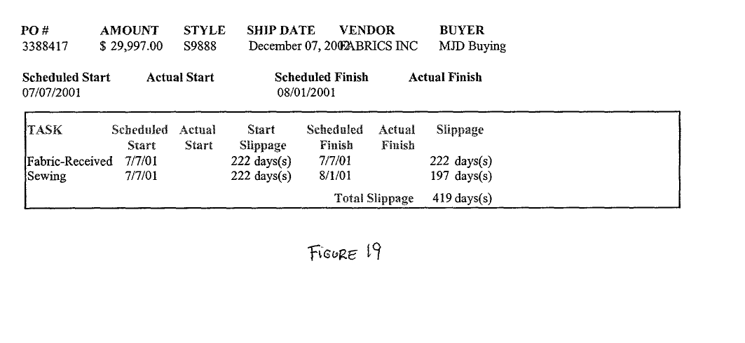

Choosing the Schedule hypertext 1604 takes the user to the Production Schedule window 1700 Shown in FIG. 18. The Production Schedule window 1700 is read-only except for the main menu 1702, a hypertext link 1704 allowing for printing of the production schedule in report form, and a hypertext link 1706 to the PO entry/edit window 100. Choosing the Exception Report hypertext 1606 takes the user to a printable report illustrated in FIG. 19. In the example report of FIG. 19, dates are shown as *slippage* for both tasks entered for PO#3388417.

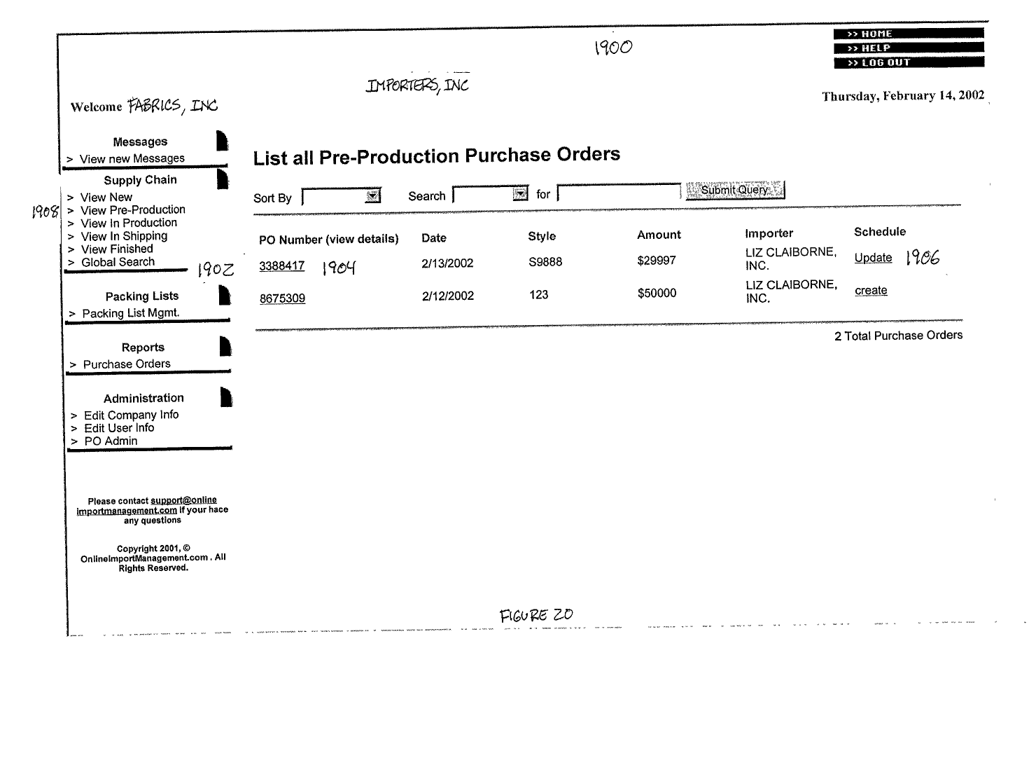

Returning to a vendor user's view of PO#3383417, FIG. 20 illustrates the vendor user's List all Pre-Production POs window 1900 at this point. This window is accessible to the vendor user via the View Pre-Production hypertext 1908 in the main menu. The entry 1902 for PO#3383417 contains a hypertext link 1904 to a read-only version of the PO. The entry 1902 also contains a hypertext link 1906 to a window for updating the PO in a fashion described in the disclosure regarding FIGS. 4 and 5.

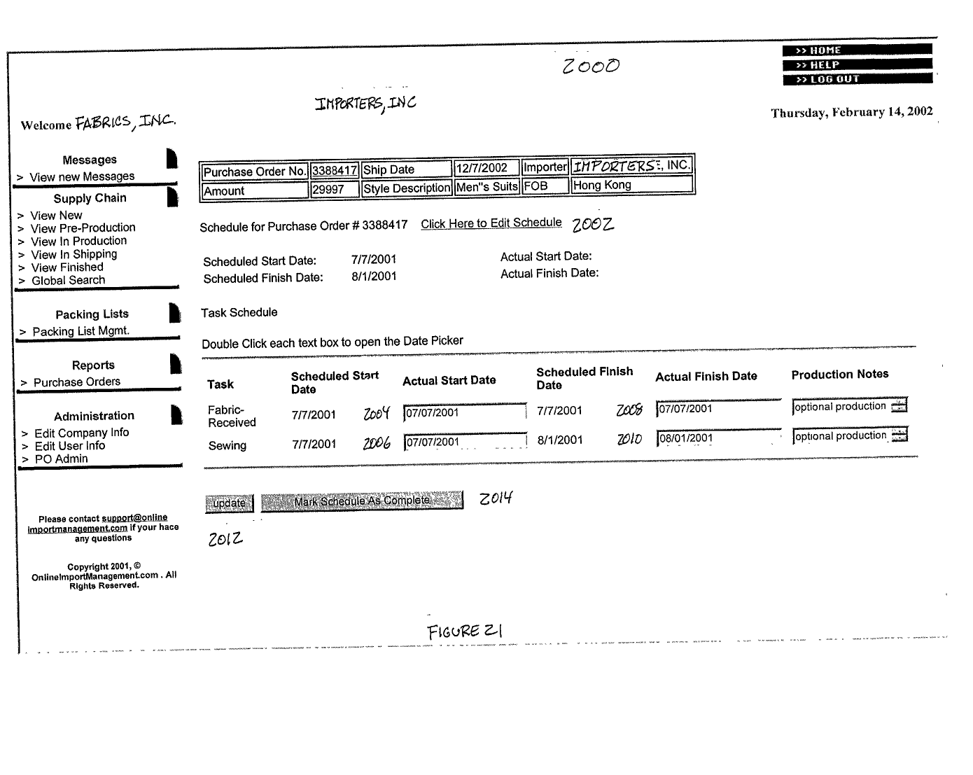

Choosing this hyperlink 1906 takes the user to the vendor user's production schedule update window 2000, illustrated in FIG. 21. This window 2000 offers a user a hypertext ha link 2002 through which to edit the schedule in the manner presented in FIG. 15. The window 2000 also offers the user the opportunity to enter actual dates in a series of panes 2004, 2006, 2008, 2010. Dates may be entered one pane at a time; after which the schedule may be updated using the Update button 2012.

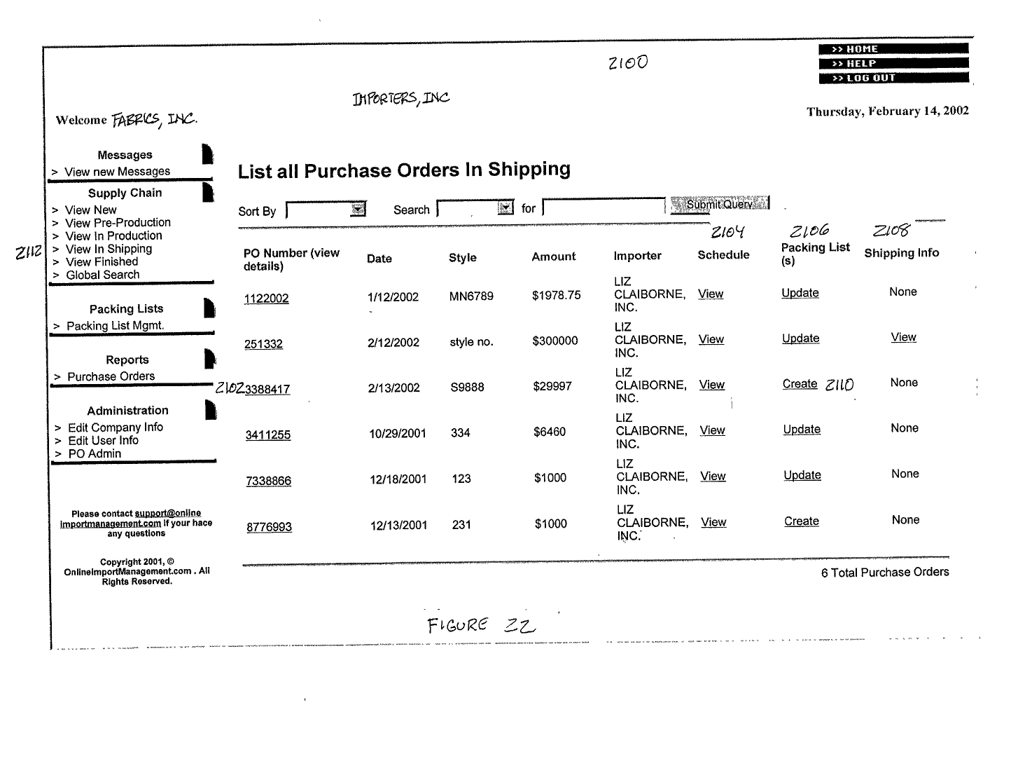

This action sends a message to those users concerned with the schedule in a fashion similar to the messages discussed with reference to FIG. 16 and causes the PO to be listed on the List all POs in Shipping window 2100 as in the entry 2102 illustrated in FIG. 22. The entry 2102 also appears in similar windows accessible by the Forwarder/Consolidator, the Buying Agent, and the Customs Broker indicated by the importer user in creating or editing the PO as described with reference to FIG. 3.

The List all POs In Shipping window 2100 provides a hypertext link to the production schedule 2104, provides hypertext options regarding a packing list 2106, and provides a link 2108 to shipping information if such information exists (for PO#3388417 such information does not yet exist). This window, and others like it for the Importer, Buying Agent, Customs Broker, and Forwarder/Consolidator, is available through the View In Shipping hypertext 2112 of each user's main menu. For PO#3388417, the user may create a packing list via the Create hyperlink 2110 under the Packing List(s) column 2106 corresponding to the entry 2102 for PO#3388417.

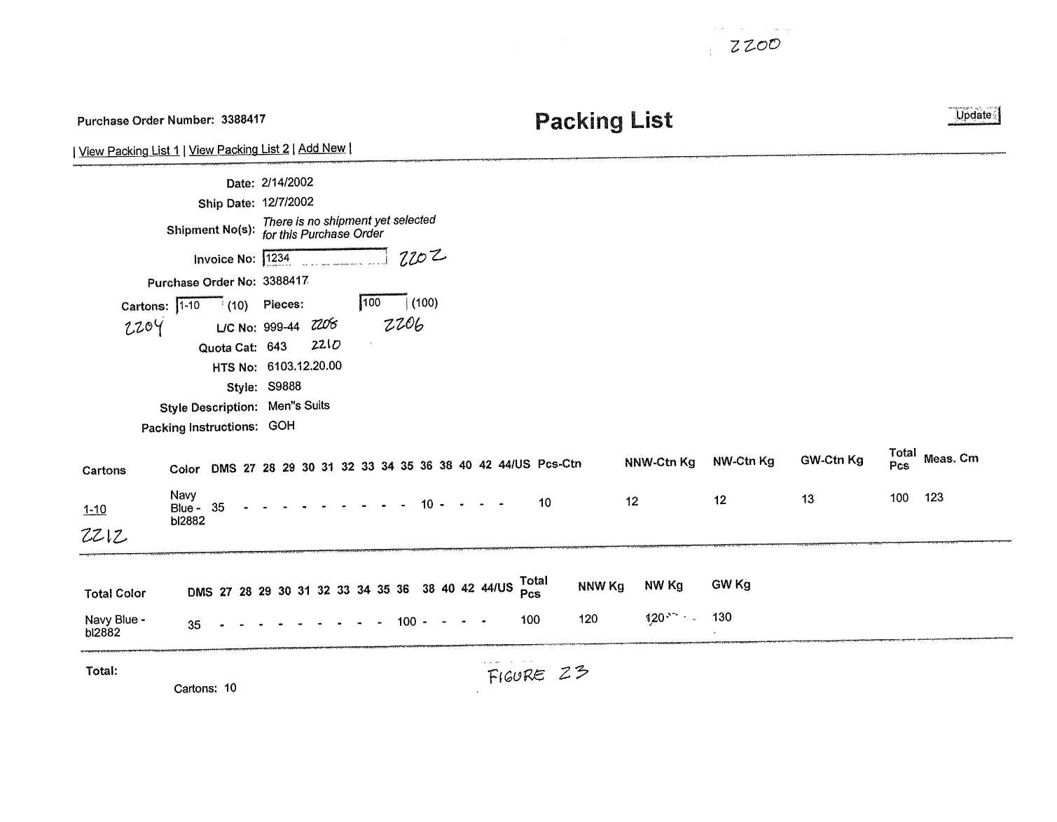

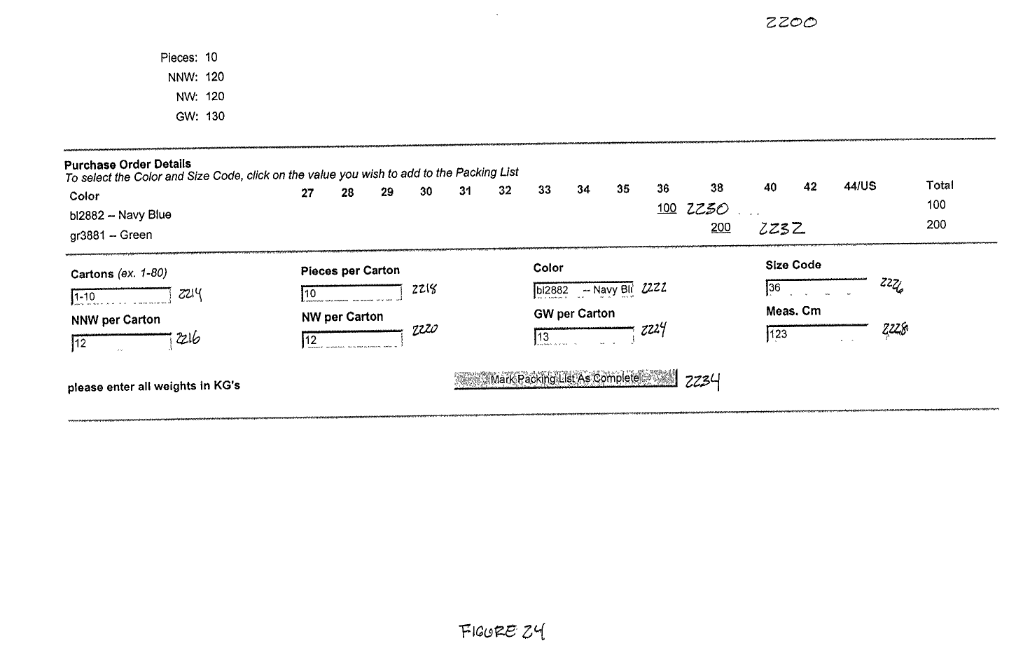

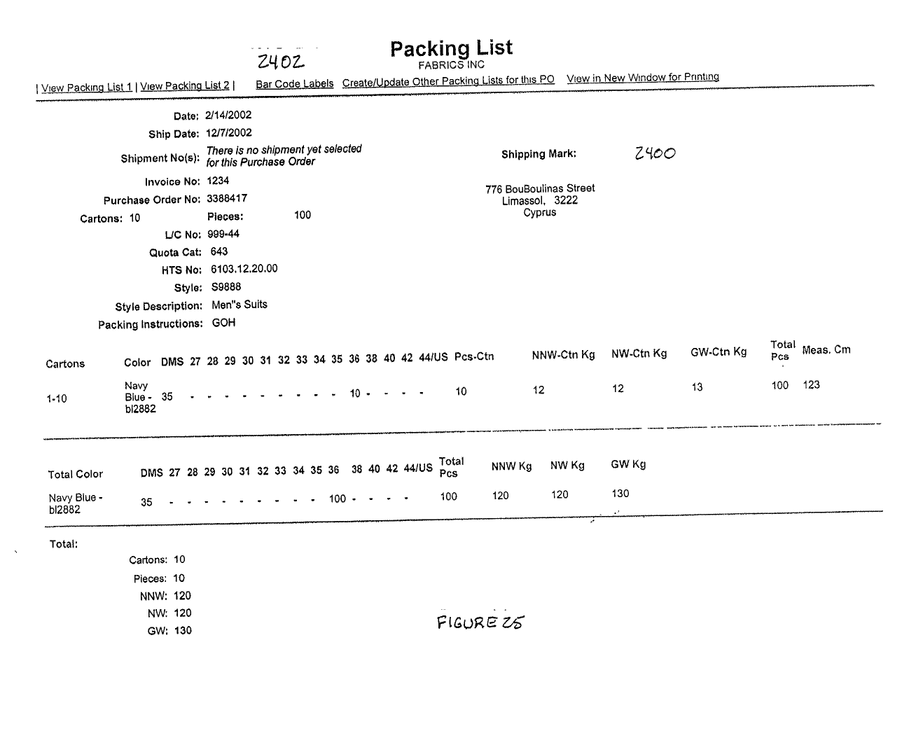

Through this link 2110 a vendor user has access to the Packing List window 2200 illustrated in FIGS. 23 and 24. Here the user may supply an invoice number and details for any number of invoices used to ship the goods of the PO. In FIG. 23, a packing list for invoice #1234 2202 is shown. The format and size range provided by the packing list is determined by the size code group 140 chosen during creation of the PO. The packing list illustrated in FIGS. 23 and 24 contains ten (10) cartons 2204 for total of 100 pieces 2206. Information such as L/C No. 2208 and Quota Cat. 2210 is carried over from the PO. Each carton in packing list contains ten (10) navy blue size 36 men's suits with a gross weight of 13 kg per carton. This information is expressed in the line item 2212 for the packing list. The individual data panes 2214, 2216, 2218, 2220, 2222, 2224, 2226, 2228 allow input of packing list information. Selecting a hypertext quantity 2230, 2232 automatically populates these data panes with relevant characteristics of the quantity selected. Marking the packing list complete using the button 2234 provided in the Packing List window 2200 moves the user to the Packing List window 2400 depicted in FIG. 25.

In the completed Packing List window 2400, none of the data elements are directly editable and the user is presented choices via hypertext links to create Bar Code Labels 2402, Create/Update Other Packing Lists for this PO 2404, or View 2406 the current packing list in a report format for printing.

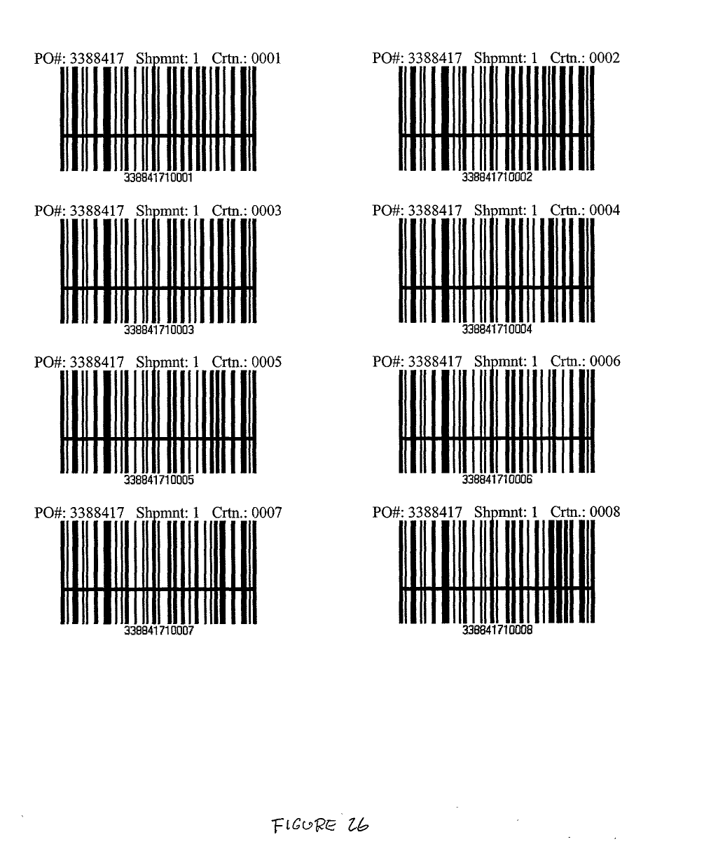

Selecting the Bar Code Label 2402 hyperlink provides a printable set of bar code labels for the cartons as shown in FIG. 26. At this point, the vendor has completed input.

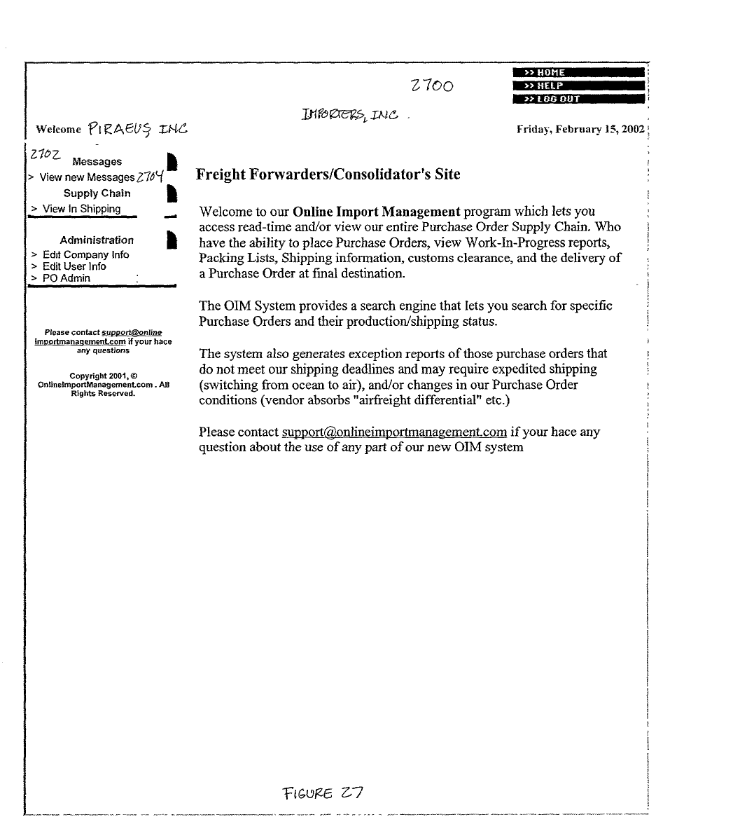

FIG. 27 illustrates the window presented to a forwarder/consolidator user upon log-in. The menu 2702 presented to the forwarder/consolidator user is more limited that that available to a vendor user. Specifically, a forwarder/consolidator user may not view new, pre-production, or production POs, nor may the forwarder consolidator user view finished POs. The forwarder/consolidator user may not manage packing lists or view PO reports. While these are the constraints of the disclosed embodiment, other embodiments of the invention may offer a different mix of privileges to forwarder/consolidators either individually or as a group.

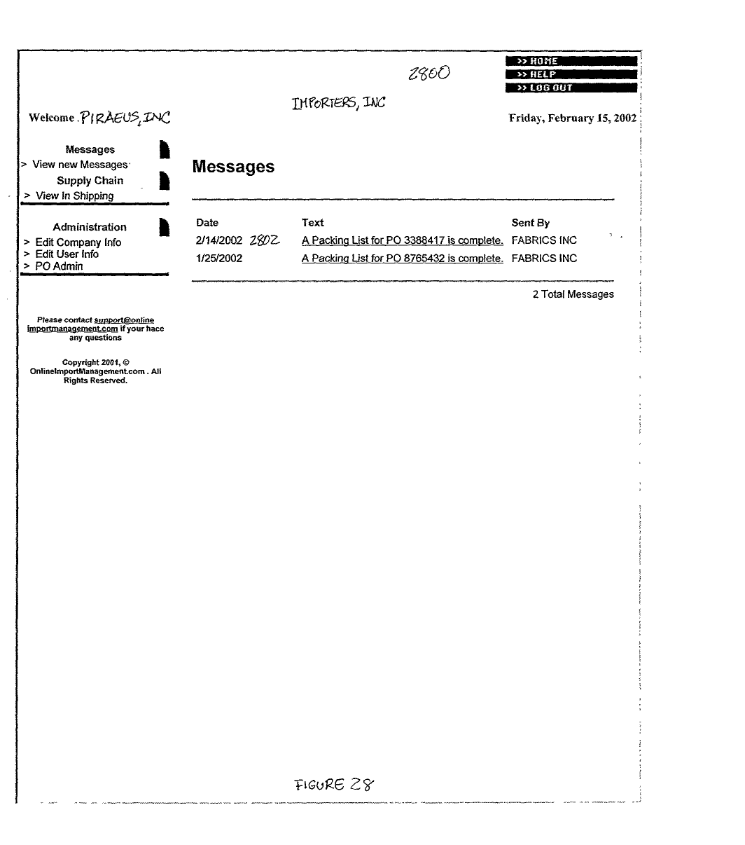

Choosing the View New Messages hypertext 2704 from the menu 2704 presents the forwarder/consolidator user with the forwarder/consolidator message window 2800 shown in FIG. 28. FIG. 28 includes an entry 2802 noting that a packing list for PO#3388417 is completed, i.e., ready for the forwarder/consolidator to participate in the process. This message entry 2802, also appears in a similar window for the buying agent (if any) designated by the importer, e.g., via Window 100.

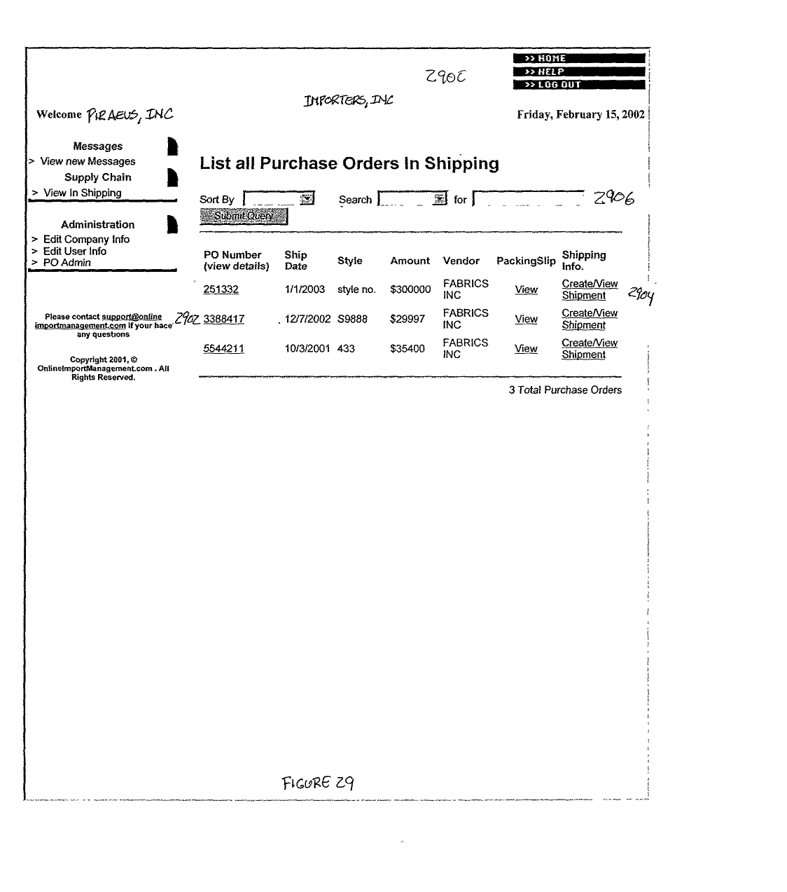

FIG. 29 illustrates the List all POs in Shipping window 2900 presented to a forwarder/consolidator user after choosing the hypertext link 2802 for a message from the Messages window 2800. Each entry, e.g., 2902 allows the forwarder/consolidator user several choices: view details of a PO in a non-editable format; view details of packing lists in non-editable form; and Create/View Shipment information 2904. To aid in locating a particular entry when the list of PO in shipping becomes longer, preferred embodiments of the invention offer sort and search functionality 2906 as described earlier.

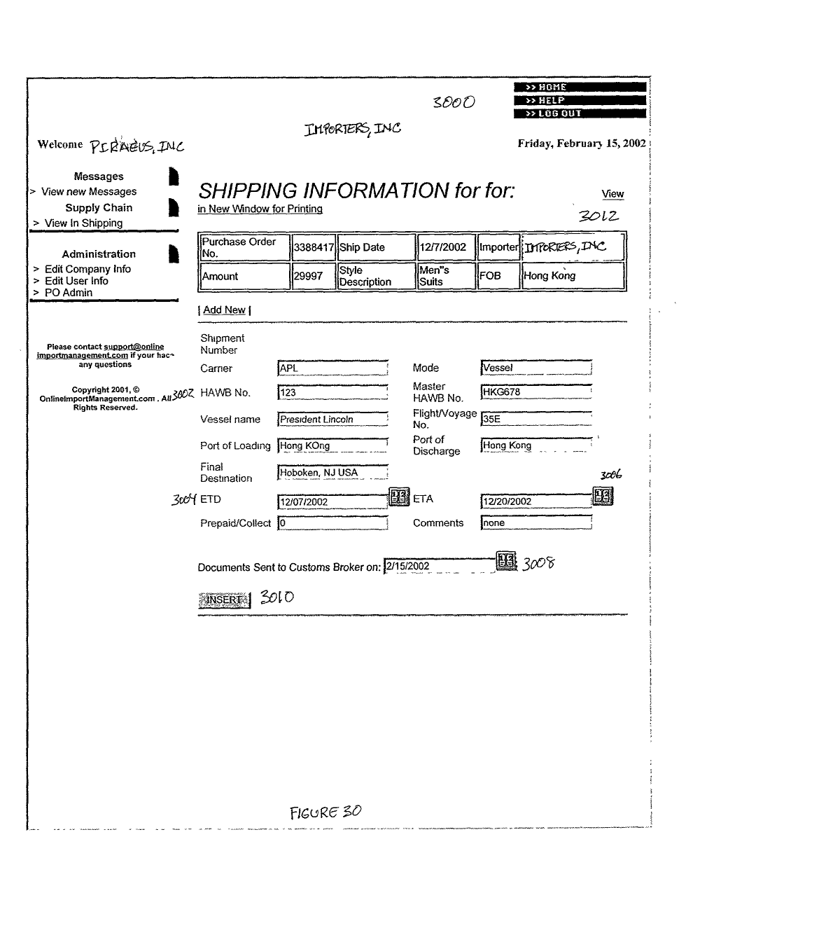

FIG. 30 illustrates the Shipping Information window 3000 presented upon selection of the Create/View Shipment hypertext 2904 from window 2900—in this example, populated with information related to a shipment associated with PO#3388417. Included in the data provided are entries for HAWB 3002, estimated time of departure (ETD) 3002, and estimated time of arrival at the destination (ETA) 3004. To link the shipping information to the Customs Broker, a pane 3008 is provided for entry of the date when customs documents were sent. After adding the appropriate data, a forwarder/consolidator user may save the shipping information by selecting the Insert button 3010 or view the information in a report format using the View in New Window for Printing hypertext 3012.

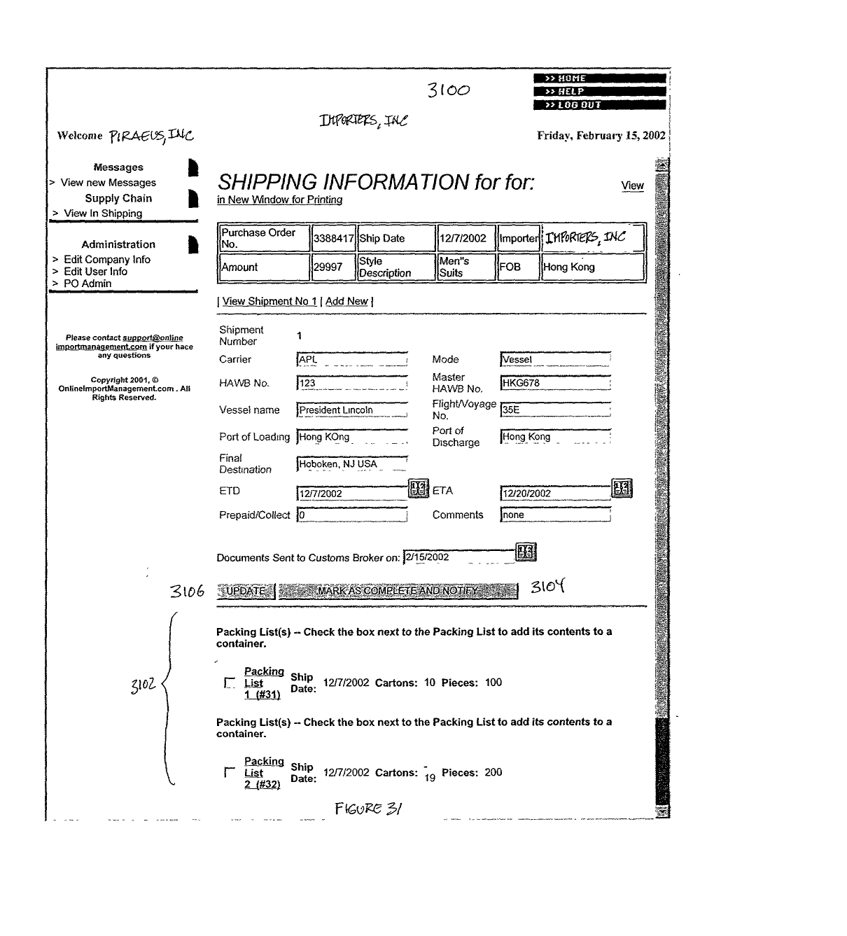

FIG. 31 illustrates the inserted data for Shipment No. 1 under PO#3388417 and offers the forwarder/consolidator user the option of individually including each established Packing List for the PO in this particular shipment 3102. In addition, the forwarder/consolidator may mark the shipping list as complete 3104, or edit and update 3106 the shipping list.

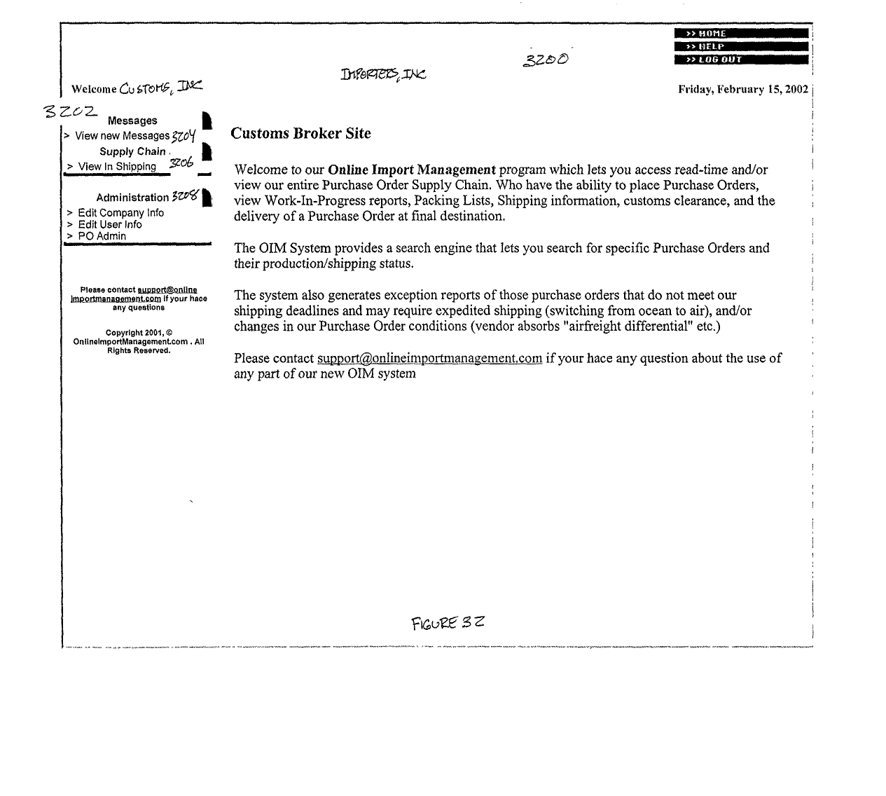

An authorized customs broker, after clearing the log in window (see FIG. 1) is presented with the Customs Broker Site window 3200 as illustrated in FIG. 32. The customs broker main menu 3202 limits custom broker users to a few options: View new Messages 3204; View In Shipping 3206, and Administration functions 3208 (for those users given administration privileges). Principally, a customs broker user is intended to provide customs information after shipping documents have been sent.

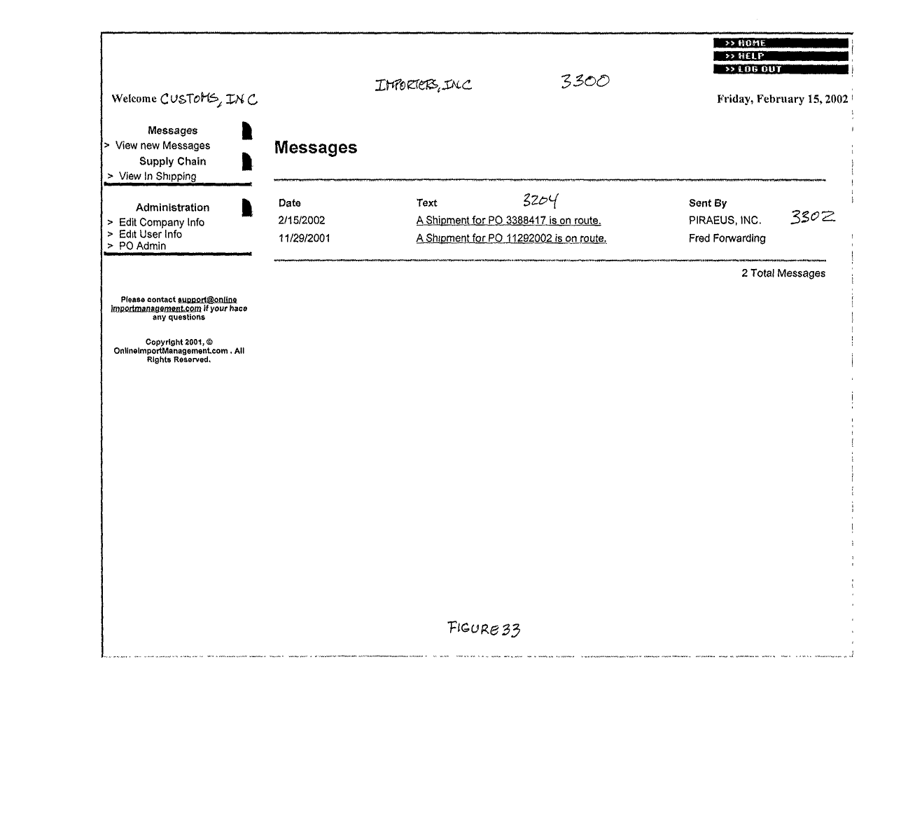

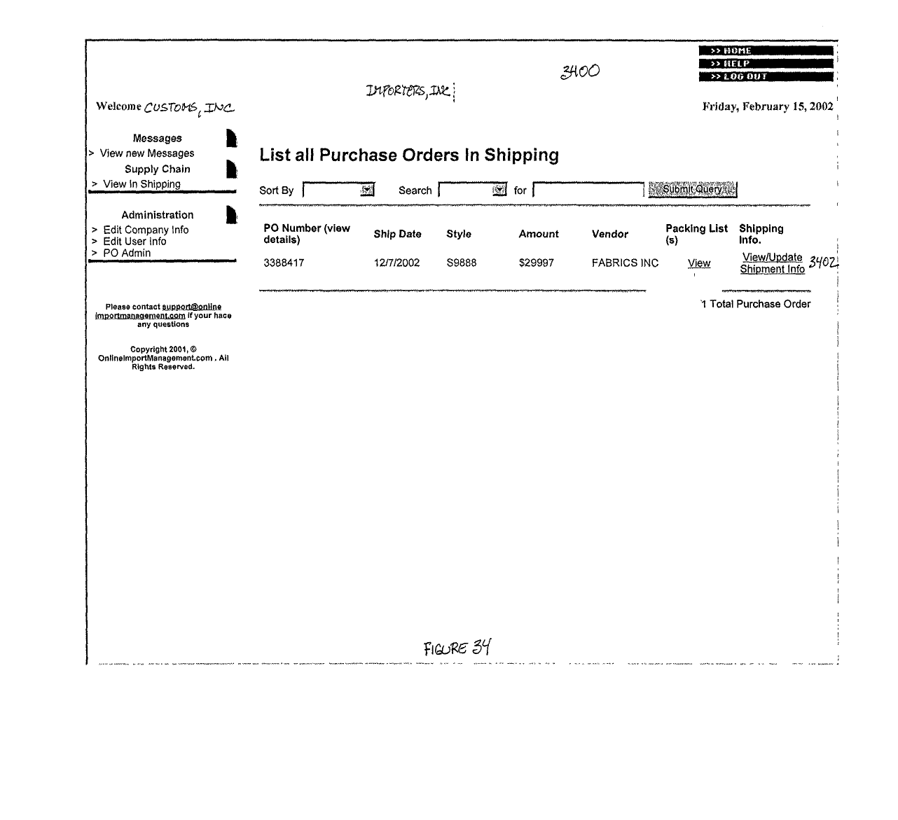

The customs broker user is notified that shipping documents have been sent through a message from the system accessible via the customs broker user's Message window 3300 as illustrated in FIG. 33. The message entry 3302 indicates the date the message was sent (e.g., Feb. 15, 2002), a text title (e.g., “A Shipment for PO 3388417 is on route”), and the user whose action triggered sending of the message by the system (e.g., PIRAEUS, INC.). This message also appears in the message windows for other users, e.g., the importer. Selecting the message hypertext 3204 causes the system to present the customs broker user with the window 3400 illustrated in FIG. 34.

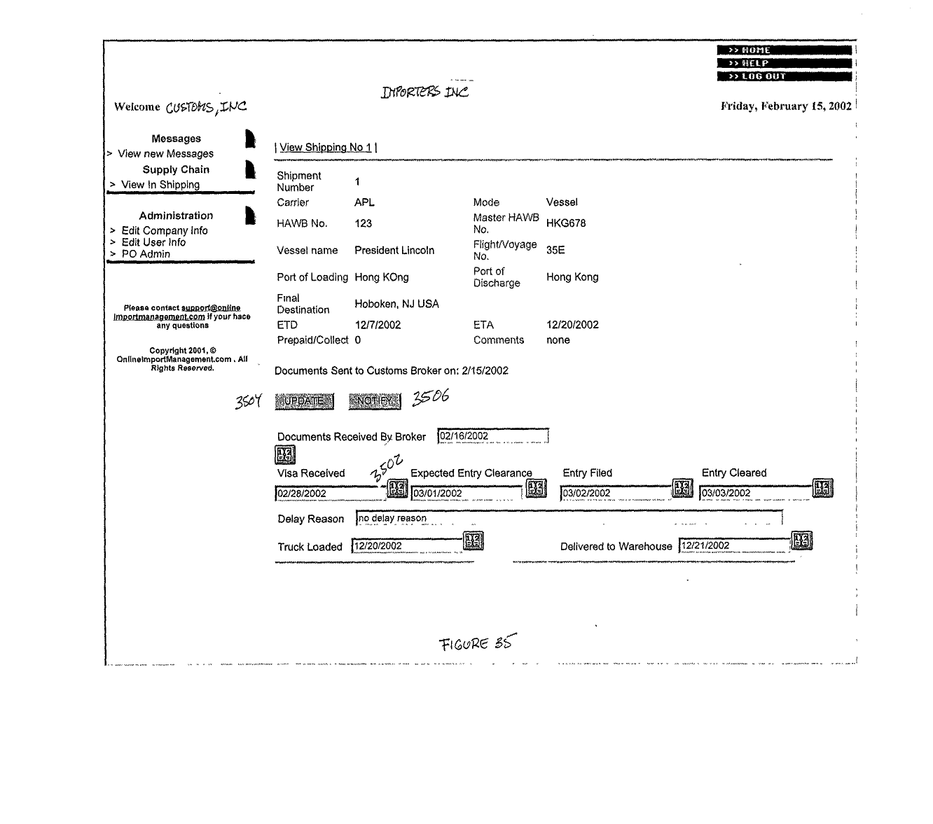

The List all POs In Shipping window 3400 presented to a customs broker user is similar in layout and functionality to window 2100 for vendor users. But in this case, the customs user, via the View/Update Shipment Info hypertext 3402 has access to the customs portion of each shipment associated with the PO. FIG. 35 illustrates the shipping information window 3500 providing this access to a customs broker user. Using this window, a customs user may identify, using direct entry or calendar button 3502, the date of a variety of event associated with customs and delivery activities—in this fashion, updating this common information source for all participants. Upon adding information, the customs broker user can update using the appropriate button 3504 and notify 3506 other users authorized to see information about this PO.

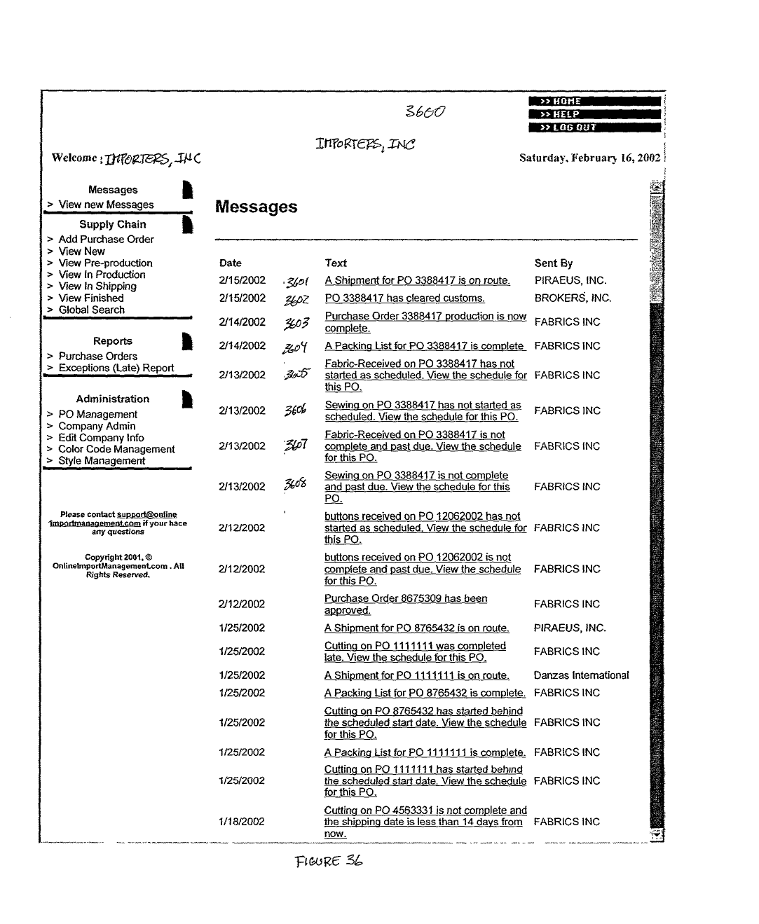

FIG. 36 illustrates the notifications received by the importer user. The first eight (8) notifications 3601-3608 related to PO#3388417's progress through the production, shipping, customs, and delivery cycle. Selecting the hypertext of any one of these messages will present the importer user with information details supporting the text.

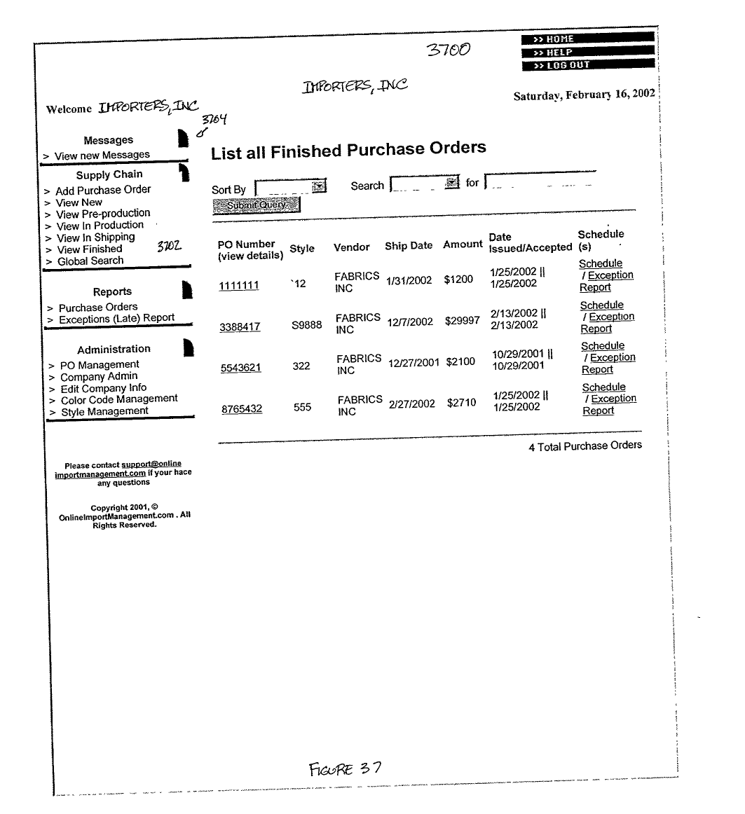

By selecting the View Finished hypertext 3702 in the importer user's menu 3704, the importer user gains access to a window 3700 displaying a List all Finished POs, as illusrated in FIG. 37. This window 3700 allows access to non-interactive views of the PO, schedule, and exception reports for finished POs. Vendors and buying agents can also view similar windows for those POs that they have been indicated as participating in.

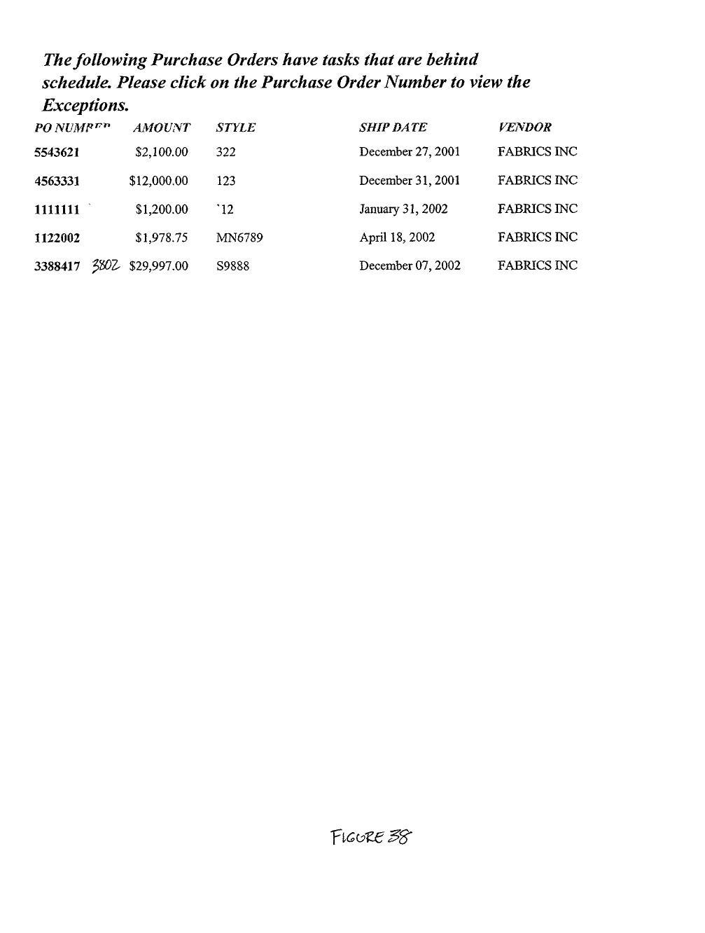

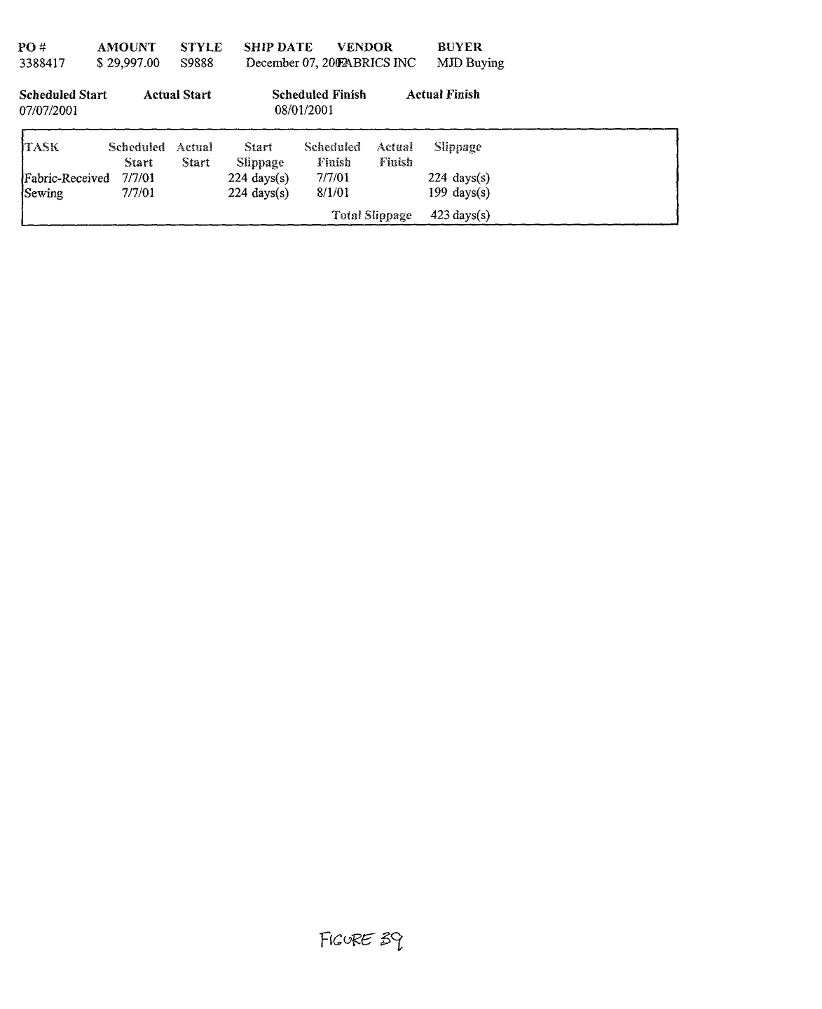

Importers and buying agents, in addition to having access to supply chain functions as described above, have access to Report functions regarding individual POs and exception reports (See FIG. 2 items 52, 54). Exception reports, an example of which is illustrated in FIG. 38, are a summary of exceptions found across all POs for the particular user. Hypertext PO numbers 3802 provide links to the specific exception report, see FIG. 39 for an example. These reports and the messages notifying a user are generated automatically by the system in accordance with rules which can be set for each Importer. An example rule is: completion of finishing cannot be later than seven (7) days before vessel shipping date.. Read-only PO reports as illustrated previously are available through the POs hyperlink (FIG. 2, item 54) on the main menu.

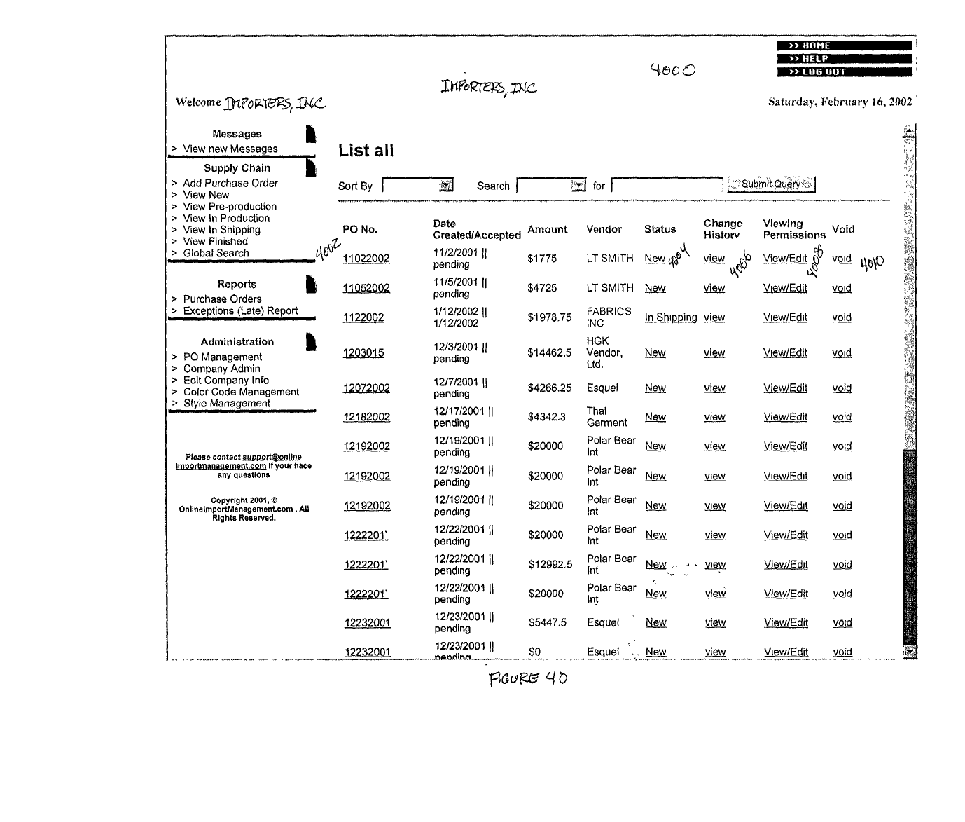

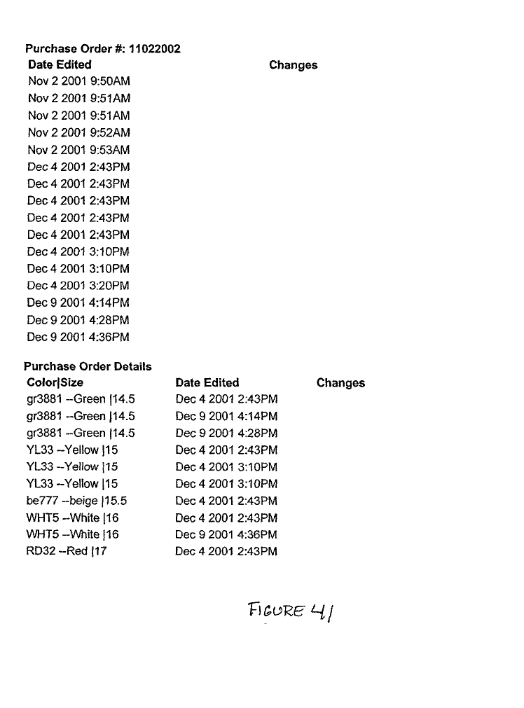

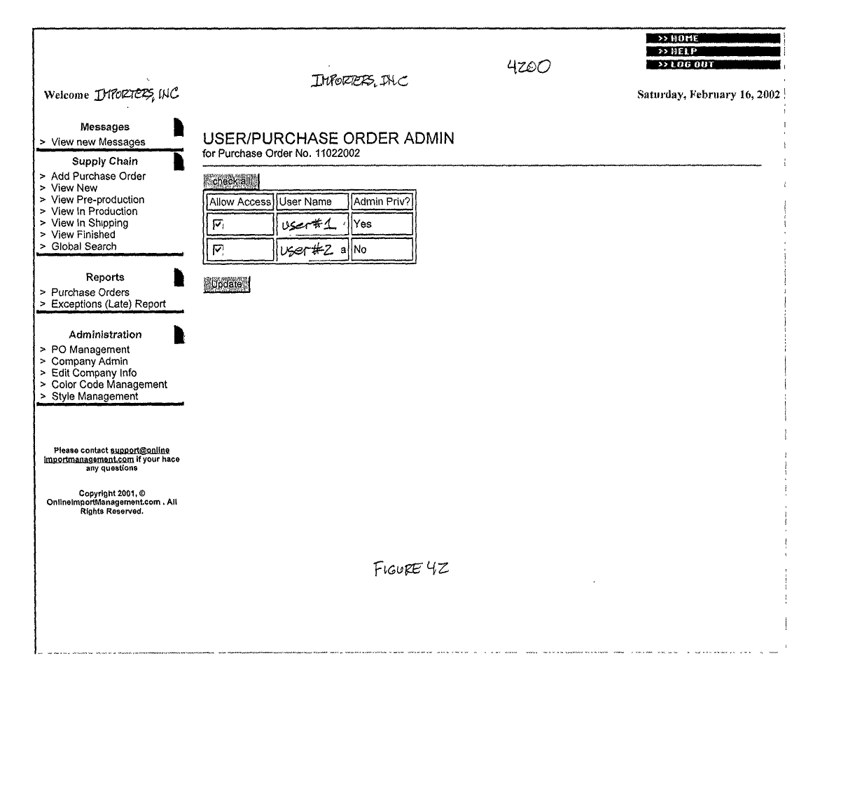

Each user has access to Administration functions (FIG. 2, item 56). Importer users and buying agent users have access to PO Management functions in addition to PO functions described to this point. FIG. 40 illustrates the PO management window 4000 for an importer user. The importer user has access to PO edit functions via the hypertext for the PO, e.g., 4002 as described with reference to FIG. 3. The importer user may change windows to the appropriate supply chain stage via the hypertext link, e.g., 4004, under the Status column. The importer user may view the change history of the PO via the hyperlink 4006 under the Change History column. An example change history for PO#11022002 is shown in FIG. 41. The importer user may also gain access to a window 4200 (shown in FIG. 42) for modifying viewing permissions of users having access to information about individual POs via the View/Edit hypertext 4008 under the Viewing permissions column. In addition, the importer user may void a PO using the void hyperlink text 4010 under the Void column. FIG. 42 illustrates a permissions window 4200.

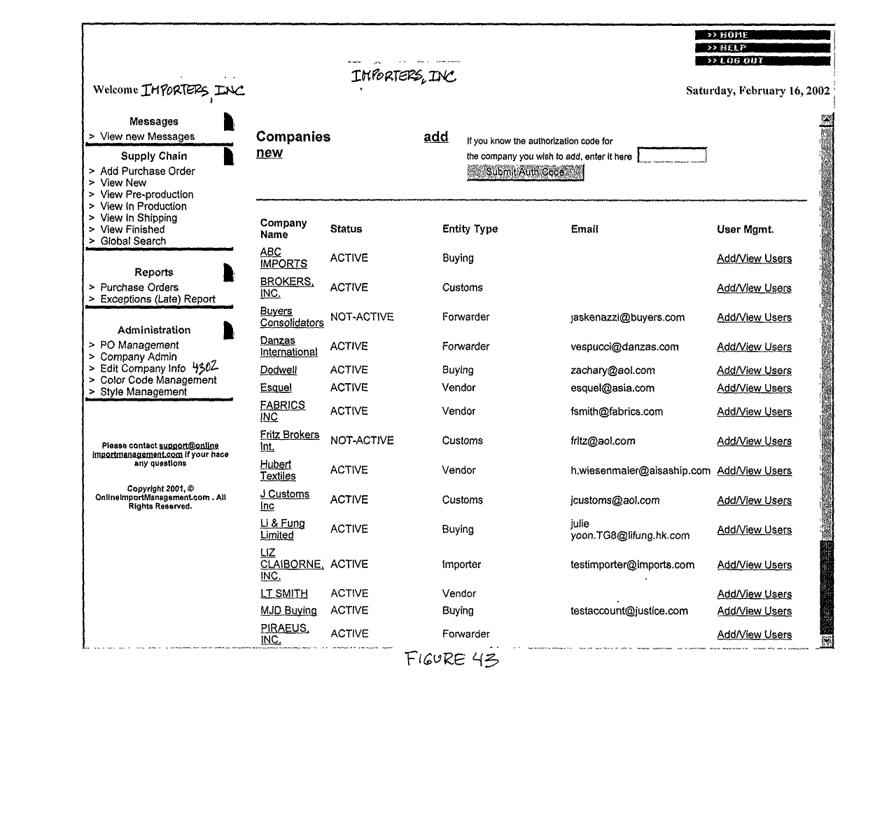

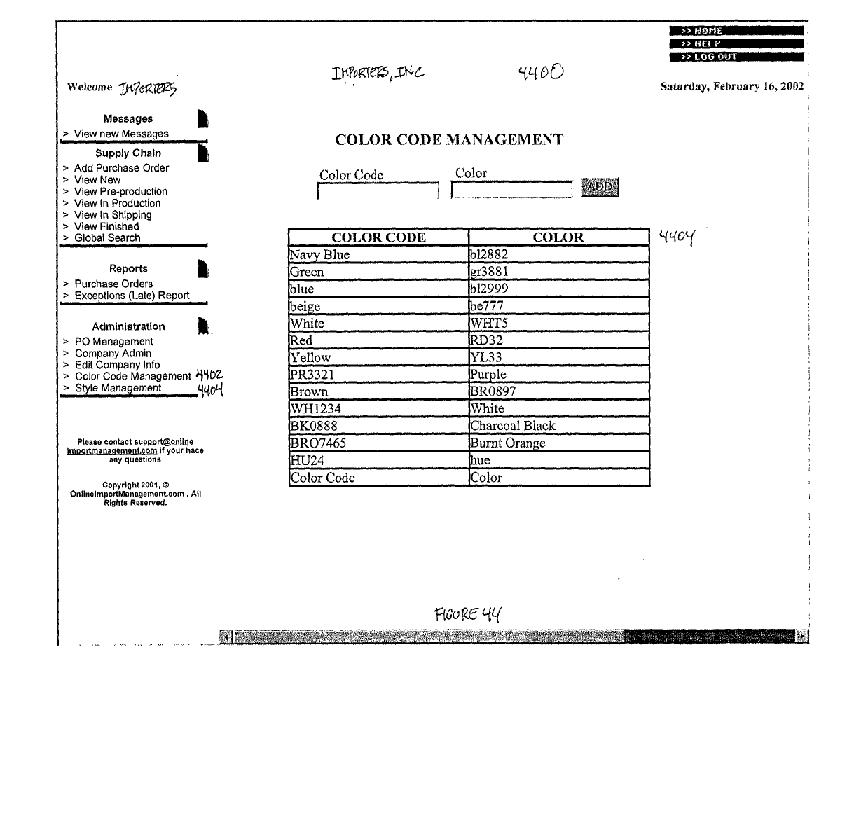

FIG. 43 illustrates a window 4300, of the type known to those skilled in the art, for controlling access by company type, by company and by individual users within a company. Using conventional methods know to those skilled, each user with administration privileges may edit and save information about that user's company via the Edit Company Info hypertext 4302. Company information includes one or more shipping addresses. FIG. 44 illustrates a color code management window 4400 of preferred embodiments of the present invention. This window is accessible to importer users via the main menu via the Color Code Management hypertext 4402. Codes listed in the table 4404 are available in the pull down menu for color code in the PO creation window 100. In a similar fashion, Style Management 4404 allows an importer user to tailor the pull down menu choices for each Style Number/Description, Quota/Quota Description, Duty Rate, HS No., Fabric Description, Fabric Origin, and Fabric Construction set available in the PO creation window 100.

1. A system for managing the ordering, production, and delivery of made-to-specification goods, the system comprising:
a computer program product configured as a network application service provider, and
comprising:
a purchase order module operative to:
create at least one purchase order data set in cooperation with a buyer user, and
notify a vendor user of the creation of each purchase order data set;
a production schedule module operative to:
indicate acceptance status of at least one purchase order data set in cooperation with a vendor user,
notify the creator of each purchase order for which acceptance status has been indicated of the acceptance status of that purchase order, and
for each accepted purchase order,
create a production schedule data set in cooperation with the accepting vendor user, and
notify
a forwarder/consolidator user and
the creator of the purchase order data set corresponding to the production schedule data set of the creation of each production schedule data set;
a shipping information module operative to
create a shipping information data set in cooperation with a forwarder/consolidator user for each production schedule data set, and
notify:
a customs broker user, each creator of the purchase order data set and the production schedule data set corresponding to the shipping information data set of the creation of the shipping information data set a viewing module
operative to allow each notified user to view and print each data set for which that user has been notified.

2. The system of claim 1 further comprising:
A customs module operative to:
create at least one customs data set in cooperation with a customs broker user for each at least one shipping information data set, and
notify each creator of the purchase order data set, the production schedule data set, and the shipping data set corresponding to the customs data set of the creation of the customs data set.

3. The system of claim 1 further comprising:
notifying a buying agent user at each point where the vendor user is notified.

4. The system of claim 1 further comprising:
a bar code generation module operative to generate bar code labels for cartons, bar code labels embodying packing list information for each corresponding carton.

5. The system of claim 1 wherein the network for which the system is configured is the Internet and user interaction with the system is through a browser.
